(19) United States
(12) Patent Application Publication
(10) Pub. No.: US 2016/0335614 A1
(43) Pub. Date: Nov. 17, 2016

(54) MEDIUM PROCESSING DEVICE AND MEDIUM TRANSACTION DEVICE

(71) Applicant: OKI ELECTRIC INDUSTRY CO., LTD., Tokyo (JP)

(72) Inventor: Youichi NOROTA, Tokyo (JP)

(73) Assignee: Oki Electric Industry Co., Ltd., Tokyo (JP)

(21) Appl. No.: 15/112,442

(22) PCT Filed: Dec. 16, 2014
(86) PCT No.: PCT/JP2014/083298

§ 371 Date: Jul. 19, 2016

(30) Foreign Application Priority Data
Mar. 27, 2014 (JP) 2014-066787

(51) Int. Cl. G06Q 20/10; G06Q 40/04

(52) U.S. Cl. CPC G06Q 20/1085; G06Q 40/04

(57) ABSTRACT

Illicit acquisition of a medium can be detected easily. A banknote pay-in/pay-out device 10 of an ATM 1 counts the number of banknotes of each denomination based on classification information for the banknotes prior to dispensing and after dispensing when forgotten banknotes arise in pay-out processing, thereby respectively generating pre-dispensing classification information N1 and post-dispensing classification information N2. The banknote pay-in/pay-out device 10 can thereby easily detect a change in the number of banknotes of each denomination between prior to dispensing and after dispensing by comparing the pre-dispensing classification information N1 against the post-dispensing classification information N2, and can facilitate the workload of a member of staff of a financial institution or the like when illicit activity has taken place.

### TECHNICAL FIELD

The present invention relates to a medium processing device and a medium transaction device, and is suitable for application to an automatic teller machine (ATM) that feeds out a medium such as banknotes and performs desired transactions requested by a user.

### BACKGROUND ART

ATMs and the like, for example into which a user pays in cash such as banknotes and coins, and that pay out cash to a user according to the contents of a transaction with a customer, are widely employed in financial institutions and the like.

Proposals exist for ATMs including, for example, a pay-in/pay-out section that exchanges banknotes with a user, a conveyance section that conveys banknotes, a classification section that classifies inserted banknotes by denomination and authenticity, a temporary holding section that temporarily holds inserted banknotes, banknote storage boxes that store banknotes by denomination, and a controller that performs overall control. The pay-in/pay-out section includes, for example, a receptacle that houses banknotes in a stacked state with the sheet faces of the banknotes facing along a front-rear direction, a shutter that opens and closes the receptacle, a take-in port that separates and takes in the banknotes housed in the receptacle one note at a time and passes the banknotes to the conveyance section, and a discharge port that discharges and stacks banknotes conveyed by the conveyance section into the receptacle.

In this ATM, in a pay-out transaction, on receipt of an instruction to start a pay-out transaction and a pay-out amount from a user, banknotes are fed out from the banknote storage boxes in denominations and numbers making up the pay-out amount. The banknotes are classified one note at a time by denomination, conveyance state, and the like, and banknotes that can be paid out are conveyed in sequence to the pay-in/pay-out section and discharged from the discharge port into the receptacle. The ATM then opens the shutter of the pay-in/pay-out section and prompts the user to take out the banknotes in the receptacle.

Note that in cases in which the user does not take out the banknotes in the pay-in/pay-out section within a specific amount of time, the ATM determines that the user has forgotten to take the banknotes and departed, namely that the paid out banknotes have been forgotten, and closes the shutter of the pay-in/pay-out section and takes in the banknotes to be conveyed to and stored in a specific dedicated storage box.

However, malicious ATM users have been known to use tricks to obtain banknotes illicitly that take advantage of the fact that paid out banknotes in the pay-in/pay-out section are taken in after a specific amount of time has elapsed.

For example, in one such trick, a normal pay-out operation is followed such that the ATM houses banknotes to be paid out in the receptacle of the pay-in/pay-out section, and opens the shutter. When this occurs, the malicious user deftly pulls out some of the banknotes in the receptacle, and after the specific amount of time has elapsed, the remaining banknotes are taken inside the ATM. Later, for example at a service counter of the financial institution, the malicious user files a claim for forgotten banknotes for the total amount that was paid out, thereby illicitly obtaining extra banknotes corresponding to the amount that they pulled out.

In another such trick, a normal pay-out operation is followed such that the ATM houses banknotes to be paid out in the receptacle of the pay-in/pay-out section, and opens the shutter. When this occurs, the malicious user deftly swaps some or all of the banknotes in the receptacle for banknotes that have been counterfeited (referred to as counterfeit notes). After the specific amount of time has elapsed, the banknotes, including the counterfeit notes, are taken inside the ATM. Later, for example at a service counter of the financial institution, the malicious user files a claim for forgotten banknotes, thereby illicitly obtaining other, genuine, banknotes corresponding to the forgotten amount.

Accordingly, there have been proposals for ATMs such as that described in the pamphlet of International Publication (WO) No. 2009/150701 that performs processing to classify the authenticity of taken in banknotes in the classification section and count the number of taken in banknotes when paid out banknotes have been forgotten. In cases in which, for example, the number of banknotes has changed, or cases in which counterfeit notes are present, another system is alerted, or the counterfeit notes are conveyed to a dedicated counterfeit note storage box to be stored.

### SUMMARY OF INVENTION

### Technical Problem

However, even more sophisticated tricks are constantly being devised that may not be adequately countered by ATMs configured in this manner using existing methods. There is accordingly demand for new methods capable of countering such new tricks.

In consideration of the above circumstances, the present invention proposes a medium processing device and a medium transaction device enabling easy detection of illicit acquisition of a medium.

### Solution to Problem

A medium processing device of the present invention addressing the above issue includes a classification section that classifies a medium, a classification information generation section that, based on a classification result by the classification section, generates information relating to the medium subject to classification as classification information, an exchange section that dispenses any of the medium to be exchanged with a user in a state in which the medium can be taken by the user, a take-in section that takes in any of the medium left behind in the exchange section, and a controller that causes the classification section to classify the medium to be exchanged with the user, that causes the classification information generation section to generate pre-dispensing classification information based on a classification result of the classification section for the medium prior to dispensing the medium, that causes the classification section to classify the medium taken in by the take-in section, that causes the classification information generation section to generate post-dispensing classification information based on a classification result of the classification section for the medium left behind in the exchange section after dispensing, and that determines any difference between the medium dispensed into the exchange section and the medium taken in by the take-in section based on the pre-dispensing classification information and the post-dispensing classification information.

A medium transaction device of the present invention includes an operation section that receives an operation instruction to perform a transaction involving an exchange of a medium with a user, a classification section that classifies the medium, a classification information generation section that, based on a classification result by the classification section, generates information relating to the medium subject to exchange as classification information, an exchange section that dispenses any of the medium subject to exchange in a state in which the medium can be taken by the user, a take-in section that takes in any of the medium left behind in the exchange section, and a controller that causes the classification section to classify the medium subject to exchange, that causes the classification information generation section to generate pre-dispensing classification information based on a classification result of the classification section for the medium prior to dispensing the medium into the exchange section, that causes the classification section to classify the medium taken in by the take-in section, that causes the classification information generation section to generate post-dispensing classification information based on a classification result of the classification section for the medium left behind in the exchange section after dispensing, and that determines any difference between the medium dispensed into the exchange section and the medium taken in by the take-in section based on the pre-dispensing classification information and the post-dispensing classification information.

The present invention enables any change in the medium between prior to dispensing and after the transaction to be determined easily in cases in which the medium dispensed into the exchange section is not taken by the user, based on the pre-dispensing classification information and the post-dispensing classification information generated based on the classification results of the medium.

### Advantageous Effects of Invention

According to the present invention, any change in the medium between prior to dispensing and after the transaction can be determined easily based on the pre-dispensing classification information and the post-dispensing classification information in cases in which the medium dispensed into the exchange section is not taken by the user. That is to say, the present invention enables a medium processing device and a medium transaction device enabling easy detection of illicit acquisition of a medium by swapping a portion of the dispensed medium and then deliberately leaving the medium behind.

### BRIEF DESCRIPTION OF DRAWINGS

FIG. 1 is a schematic perspective view illustrating configuration of an ATM.

FIG. 2 is a schematic line drawing illustrating configuration of a banknote pay-in/pay-out device.

FIG. 3 is a schematic line drawing illustrating a block configuration of an ATM and a banknote pay-in/pay-out device.

FIG. 4 is a flowchart illustrating a pay-out processing routine according to a first exemplary embodiment.

FIGS. 5A and 5B are schematic line drawings illustrating classification information according to the first exemplary embodiment.

FIG. 6 is a flowchart illustrating a pay-out processing routine according to a second exemplary embodiment.

FIGS. 7A and 7B are schematic line drawings illustrating classification information according to the second exemplary embodiment.

FIGS. 8A and 8B are schematic line drawings illustrating configuration of a banknote.

FIG. 9 is a schematic line drawing illustrating orientations of a banknote.

FIG. 10 is a flowchart illustrating a pay-out processing routine according to a third exemplary embodiment.

FIGS. 11A and 11B are schematic line drawings illustrating classification information according to the third exemplary embodiment.

FIG. 12 is a flowchart illustrating a pay-out processing routine according to a fourth exemplary embodiment.

FIGS. 13A and 13B are schematic line drawings illustrating classification information according to the fourth exemplary embodiment.

FIGS. 14A and 14B are schematic line drawings illustrating placement of various detection sensors in a pay-in/pay-out section.

FIG. 15 is a flowchart illustrating a pay-out processing routine (1) according to a fifth exemplary embodiment.

FIG. 16 is a flowchart illustrating a pay-out processing routine (2) according to the fifth exemplary embodiment.

### DESCRIPTION OF EMBODIMENTS

Explanation follows regarding embodiments of the present invention (referred to below as exemplary embodiments), with reference to the drawings.

### 1. First Exemplary Embodiment

### 1-1. ATM Configuration

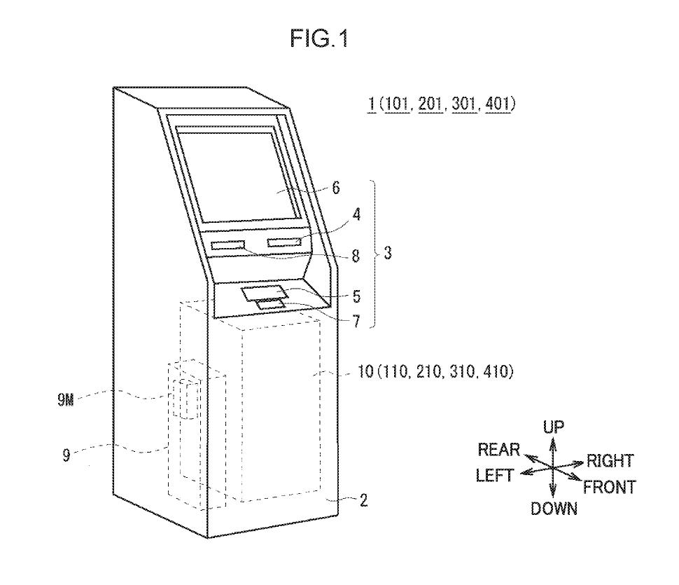

As illustrated in the external view of FIG. 1, an ATM 1 is configured around a box-shaped casing 2, and is, for example, installed in a financial institution or the like to perform cash transactions such as pay-in transactions and pay-out transactions for a customer. In the following explanation, the front side is defined as the side of the ATM 1 facing the customer, and the opposite side thereto is defined as the rear side. The left side, right side, upper side and lower side are defined from the perspective of the left and right as seen by a customer facing the front side.

The casing 2 is provided with a customer interface 3 at a location enabling easy banknote insertion, easy operation of a touch panel, and the like by a customer facing the front side of the casing 2, namely at a portion cut away obliquely in a shape spanning from an upper part of a front face to an upper face. The customer interface 3 directly handles cash and passbook transactions and the like with the customer, notifies transaction-related information, and receives operation instructions. The customer interface 3 is provided with a card insertion/removal port 4, a pay-in/pay-out port 5, an operation and display section 6, a ten-key 7, and a receipt issue port 8.

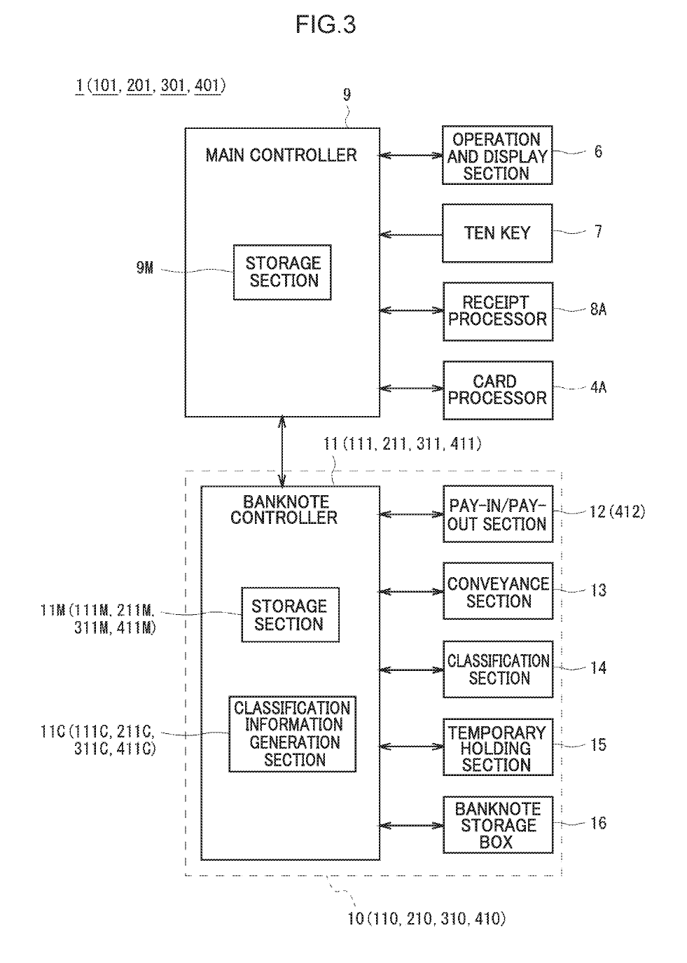

The card insertion/removal port 4 is a section for insertion and return of various cards, such as cash cards. A card processor 4A (FIG. 3) that reads, for example, account numbers magnetically recorded on the various cards is provided behind the card insertion/removal port 4. The pay-in/pay-out port 5 is a section into which banknotes for paying in are inserted by a customer, and where banknotes for paying out to a customer are dispensed. The pay-in/pay-out port 5 is opened and closed by driving a shutter.

The operation and display section 6 is a touch panel integrated with a Liquid Crystal Display (LCD) that displays operation screens during transactions, and a touch sensor that is input with, for example, a transaction type selection, a PIN, or a transaction amount. The ten-key 7 is, for example, a physical keypad that is input with the numbers 0 to 9. The ten-key 7 is employed during PIN and transaction amount input operations and the like. The receipt issue port 8 is a section that issues a receipt printed with transaction details and the like at the end of transaction processing. A receipt processor 8A (FIG. 3) that prints the transaction details and the like on the receipt is, for example, provided behind the receipt issue port 8.

A main controller 9 that performs general control of the overall ATM 1, a banknote pay-in/pay-out device 10 that performs various processing relating to banknotes, and the like are provided inside the casing 2.

The main controller 9 is configured around a Central Processing Unit (CPU), not illustrated in the drawings. The main controller 9 reads and executes specific programs from, for example, ROM or flash memory, not illustrated in the drawings, to perform various processing such as in pay-in transactions and pay-out transactions. The main controller 9 is provided with an internal storage section 9M including, for example, Random Access Memory (RAM), a hard disk drive, or flash memory. The storage section 9M is stored with various information.

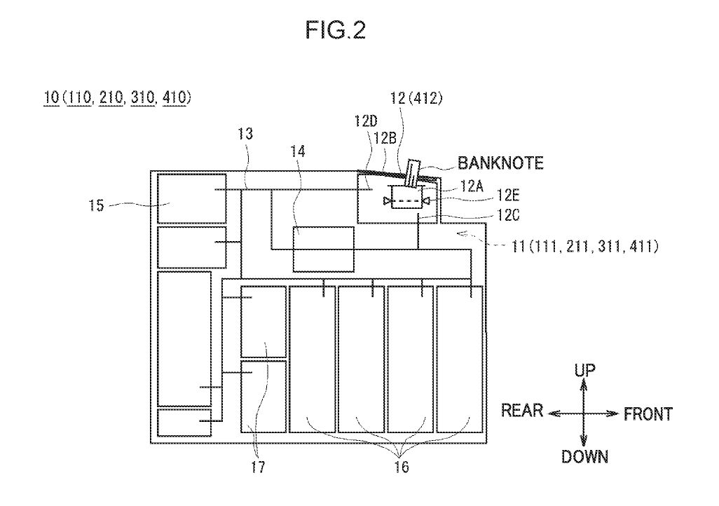

As illustrated in the side view of FIG. 2, a banknote controller 11, a pay-in/pay-out section 12, a conveyance section 13, a classification section 14, a temporary holding section 15, banknote storage boxes 16, reject boxes 17, a counterfeit note storage box 18, and a forgotten banknote storage box 19 are provided inside the banknote pay-in/pay-out device 10.

FIG. 3 illustrates a block configuration of the overall ATM 1. As illustrated by the block configuration of the banknote pay-in/pay-out device 10, the banknote controller 11 controls the overall banknote pay-in/pay-out device 10 coordinated with the main controller 9. Similarly to the main controller 9, the banknote controller 11 is configured around a CPU, not illustrated in the drawings, and reads and executes specific programs from, for example, ROM or flash memory, not illustrated in the drawings, to perform various processing such as pay-in processing and pay-out processing.

The banknote controller 11 further includes an internal storage section 11M configured by RAM, flash memory, or the like. The storage section 11M is stored with various information such as information relating to the various programs such as pay-out programs, and to banknotes. Moreover, the banknote controller 11 includes an internal classification information generation section 11C that generates classification information relating to banknotes based on classification information obtained from the classification section 14 (described in detail later).

The pay-in/pay-out section 12 (FIG. 2) is configured around an upward-opening, box-shaped receptacle 12A. The receptacle 12A houses banknotes to be passed to a user and banknotes received from a user. The receptacle 12A arranges banknotes, these being a rectangular paper sheet shaped medium, such that the length direction of the banknotes runs along the left-right direction and the sheet faces of the banknotes face in the front-rear direction, and can house a maximum of 200 banknotes stacked in a state in which the sheet faces of the respective banknotes face one another.

An openable and closable shutter 12B is provided above the receptacle 12A. Opening the shutter 12B allows a user to insert banknotes into the receptacle 12A, or allows a user to take out banknotes from inside the receptacle 12A, and closing the shutter 12B shields the receptacle 12A from the user, preventing banknotes from being taken out or inserted into the receptacle 12A, and preventing access such as touching the banknotes.

The pay-in/pay-out section 12 further includes a take-in port 12C that separates banknotes inside the receptacle 12A one note at a time and passes the banknotes to a conveyance section 13, and a discharge port 12D that discharges banknotes conveyed from the conveyance section 13 into the receptacle 12A. The pay-in/pay-out section 12 is also incorporated with a banknote detection sensor 12E that detects whether or not banknotes are present inside the receptacle 12A.

The banknote detection sensor 12E is what is referred to as a light sensor, in which a light emitting element that emits a specific detection light, and a light receiving element that receives the detection light, are disposed facing each other across the receptacle 12A. When the detection light is blocked, the banknote detection sensor 12E detects that one or more banknotes are being housed inside the receptacle 12A, and when the detection light is received, the banknote detection sensor 12E detects that no banknotes are being housed in the receptacle 12A. The banknote detection sensor 12E notifies the banknote controller 11 of detection results obtained in this manner, thereby enabling the banknote controller 11 to identify whether or not banknotes are present inside the receptacle 12A.

The conveyance section 13 forms a conveyance path connecting together the various sections inside the banknote pay-in/pay-out device 10 with motors, rollers, belts, guides, and the like, not illustrated in the drawings. The conveyance section 13 rotates the rollers as appropriate, and drives the belts as appropriate, to convey banknotes along the conveyance path in a direction of travel aligned with the short edges of the banknotes.

The classification section 14 includes various internal sensors, such as optical sensors, image sensors, and magnetic sensors. The classification section 14 classifies banknotes by denomination and authenticity, as well as by damage level and the like, and reads serial numbers as banknotes are conveyed through inside, and notifies the banknote controller 11 of the classification results and serial numbers. In response, the banknote controller 11 decides a conveyance destination for each banknote based on the obtained classification results.

The temporary holding section 15 employs what is referred to as a tape escrow method, and stores banknotes by wrapping banknotes onto a peripheral side face of a circular cylinder shaped drum together with a tape, and feeds out the banknotes by peeling the tape away from the peripheral side face. Note that, for example, the temporary holding section 15 is capable of storing a maximum of 200 banknotes.

Each banknote storage box 16 stacks and stores multiple banknotes internally. For example, in a pay-in transaction, the banknote storage boxes 16 take in and store banknotes conveyed by the conveyance section 13 that have been classified as reusable banknotes with a low level of damage by the classification section 14, and sorted by denomination. In a pay-out transaction, under the control of the banknote controller 11, the banknote storage boxes 16 separate and feed out an instructed number of banknotes one note at a time, and pass the banknotes to the conveyance section 13 in sequence.

The reject boxes 17 store banknotes that the classification section 14 has classified as having a high level of damage and being unsuitable for reuse (referred to as reject banknotes). The counterfeit note storage box 18 stores banknotes classified as counterfeit (referred to as counterfeit notes). The forgotten banknote storage box 19 stores banknotes that a user has forgotten to take from the pay-in/pay-out section 12 in a pay-out transaction. Note that it is sufficient for each of the reject box 17, the counterfeit note storage box 18, and the forgotten banknote storage box 19 to be capable of storing banknotes conveyed by the conveyance section 13, and thus they only include a storage function, and do not include a feed-out function such as that of the banknote storage boxes 16.

### 1-2. Pay-in Processing

Next, explanation follows regarding banknote pay-in processing in the banknote pay-in/pay-out device 10. When a user performs a pay-in transaction with the ATM 1, the banknote controller 11 of the banknote pay-in/pay-out device 10 begins pay-in processing.

First, on receipt of a pay-in transaction start operation through the operation and display section 6, working together with the main controller 9 (FIG. 1), the banknote controller 11 opens the shutter 12B of the pay-in/pay-out section 12 to allow banknotes to be inserted into the receptacle 12A. When the user has inserted banknotes into the receptacle 12A and a take-in start operation instruction has been received through the operation and display section 6, the pay-in/pay-out section 12 closes the shutter 12B and takes in the banknotes from the receptacle 12A one note at a time using the take-in port 12C, and passes the banknotes to the conveyance section 13. The conveyance section 13 moves the banknotes in a direction aligned with the short edge direction, and conveys the banknotes to the classification section 14.

The classification section 14 notifies the banknote controller 11 of the detection results of the various sensors while conveying the banknotes through the inside. When this is performed by the classification section 14, for example, sheet faces that were facing forward in the receptacle 12A face downward when inside the classification section 14, and long edges that were lower edges in the receptacle 12A becomes rear edges when inside the classification section 14.

Based on the classification results obtained from the classification section 14, the banknote controller 11 identifies the denominations, authenticity, level of damage and the like of the banknotes, and also reads the serial numbers. A serial number is a unique combination of letters and numbers assigned to each banknote, and each banknote can be individually identified by its serial number.

The banknote controller 11 also decides the conveyance destination of each banknote based on the identification results. Specifically, the banknote controller 11 uses the conveyance section 13 to convey banknotes classified as normal and suitable for transacting to the temporary holding section 15 to be stored, and uses the conveyance section 13 to convey reject banknotes classified as unsuitable for transacting to the pay-in/pay-out section 12, where they are discharged from the discharge port 12D into the receptacle 12A. The banknote controller 11 then opens the shutter 12B of the pay-in/pay-out section 12, thereby allowing the user to check the reject banknotes, exchange the reject banknotes for other banknotes as necessary, and reinsert the banknotes into the receptacle 12A.

Finally, when all of the banknotes inserted into the pay-in/pay-out section 12 have been taken in, the banknote controller 11 calculates a pay-in amount based on the classification results obtained from the classification section 14, displays this on the display section 6 so as to be presented to the user, and asks the user whether or not to continue with the pay-in transaction. When an instruction to continue with the pay-in transaction is received from the user, the banknote controller 11 uses the conveyance section 13 to convey the banknotes being held in the temporary holding section 15 to the classification section 14 to be classified by denomination, level of damage, and the like, and acquires the classification results.

The banknote controller 11 then controls the conveyance section 13 to convey banknotes with a low level of damage to the banknote storage boxes 16 to be stored as banknotes that are suitable for re-use, after being sorted by denomination by the conveyance section 13. On the other hand, the banknote controller 11 conveys banknotes with a high level of damage to the reject box 17 to be stored as reject banknotes that are unsuitable for re-use. The banknote controller 11 conveys counterfeit notes to the counterfeit note storage box 19 to be stored.

When an instruction not to continue the pay-in transaction from the user is received, the banknote controller 11 feeds out all of the banknotes held in the temporary holding section 15 in sequence, and uses the conveyance section 13 to convey the banknotes in sequence to the pay-in/pay-out section 12 and discharge the banknotes from the discharge port 12D into the receptacle 12A in sequence. When all of the banknotes have been housed in the receptacle 12A, the banknote controller 11 opens the shutter 12B to dispense the banknotes, thereby allowing the user to take out the banknotes.

When this is performed, if banknotes still remain in the receptacle 12A after a specific waiting time (for example 30 seconds) has elapsed since opening the shutter 12B, the banknote controller 11 determines that the user has forgotten to take the notes and departed. When this occurs, the banknote controller 11 takes in the banknotes in the receptacle 12A through the take-in port 12C one note at a time, and uses the conveyance section 13 to convey the banknotes to the forgotten banknote storage box 19 to be stored.

In this manner, the banknote pay-in/pay-out device 10 performs classification and decides the conveyance destination one note at a time for the banknotes inserted into the pay-in/pay-out section 12 by a user in a pay-in transaction, and conveys the banknotes to the banknote storage boxes 16 and the like to be stored.

### 1-3. Pay-Out Processing

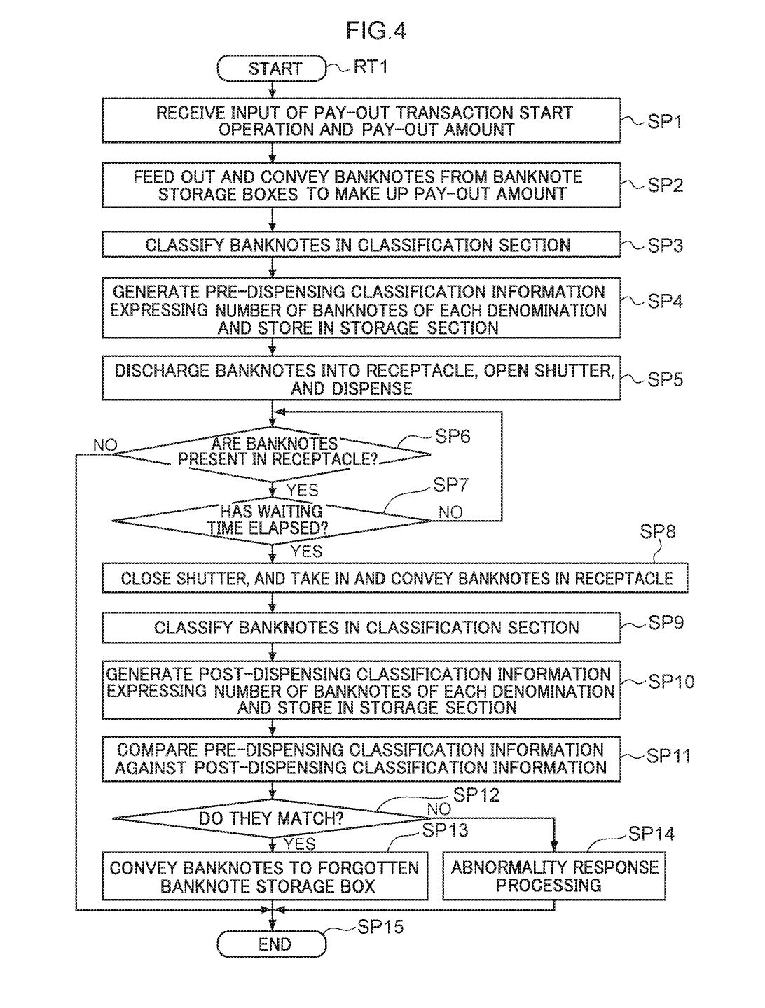

Next, explanation follows regarding banknote pay-out processing in the banknote pay-in/pay-out device 10. When a user performs a pay-out transaction with the ATM 1, the banknote controller 11 of the banknote pay-in/pay-out device 10 performs pay-out processing to pay out banknotes based on instructions from the user. Specifically, the banknote controller 11 reads and executes a pay-out program from the storage section 11M, starts the pay-out processing routine RT1 illustrated in FIG. 4, and transitions to step SP1.

At step SP1, working together with the main controller 9 (FIG. 3), the banknote controller 11 receives a pay-out transaction start operation from the user through the operation and display section 6, and is input with a pay-out amount, and then transitions to the next step SP2. At step SP2, the banknote controller 11 decides denominations and numbers of banknotes to make up the pay-out amount, then feeds out banknotes in these denominations and numbers from the banknote storage boxes 16 in sequence, and uses the conveyance section 13 to convey the banknotes to the discharge port 12D of the pay-in/pay-out section 12 via the classification section 14. The banknote controller 11 then transitions to the next step SP3.

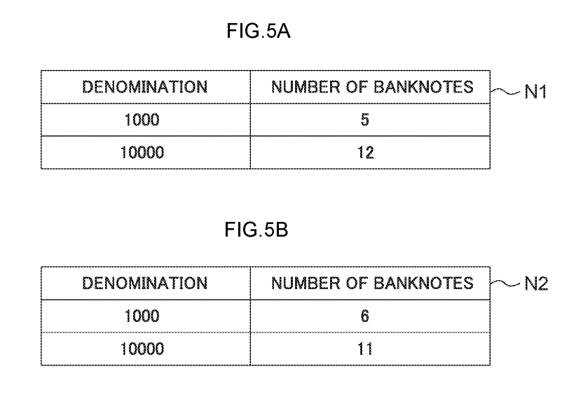

At step SP3, the banknote controller 11 classifies each banknote being conveyed in the classification section 14, before transitioning to the next step SP4. At step SP4, on obtaining the classification results for all of the banknotes to be paid out from the classification section 14, the banknote controller 11 uses the classification information generation section 11C (FIG. 3) to count the number of banknotes of each denomination based on the classification results and generate pre-dispensing classification information N1 such as that illustrated in FIG. 5A, and stores the pre-dispensing classification information N1 in the storage section 11M (FIG. 3). The banknote controller 11 then transitions to the next step SP5.

At step SP5, after completing discharge of all of the banknotes to be paid out into the receptacle 12A of the pay-in/pay-out section 12, the banknote controller 11 opens the shutter 12B and dispenses the banknotes, before transitioning to the next step SP6. When this is performed, the banknotes in the receptacle 12A are placed in a state in which they can be taken out by the user. Moreover, working together with the main controller 9 (FIG. 3), the banknote controller 11 displays a message such as “Please take your banknotes” on the operation and display section 6, or plays an alert sound from a specific speaker (not illustrated in the drawings), thereby prompting the user to take out the banknotes from the receptacle 12A.

At step SP6, the banknote controller 11 determines whether or not any banknotes remain in the receptacle 12A based on detection results obtained from the banknote detection sensor 12E. When a negative result is obtained, this means that the user has taken all of the banknotes (namely the dispensed banknotes) out from the receptacle 12A. When this occurs, the banknote controller 11 transitions to the next step SP15, and ends the pay-out processing routine RT1.

When a positive result is obtained at step SP6, this means that the user has not taken the banknotes (namely the dispensed banknotes) out from the receptacle 12A. The banknote controller 11 transitions to the next step SP7 when this occurs. At step SP7, the banknote controller determines whether or not a specific waiting time (for example 30 seconds) has elapsed since opening the shutter 12B.

When a negative result is obtained, this means that although banknotes remain in the receptacle 12A, only a short amount of time has elapsed time since opening the shutter 12B, and there is still a possibility of the user taking the banknotes out. When this occurs, the banknote controller 11 returns to step SP6, and awaits removal of the banknotes from the receptacle 12A by the user.

When a positive result is obtained at step SP7, this means that a comparatively long waiting time has elapsed since opening the shutter 12B, and banknotes remain in the receptacle 12A despite there being a high likelihood of the user having already departed from in front of the ATM 1. In other words, this means that there is a high likelihood of the user having forgotten to take the banknotes and departed. When this occurs, the banknote controller 11 transitions to the next step SP8 in order to deal with the forgotten banknotes.

At step SP8, the banknote controller 11 closes the shutter 12B of the pay-in/pay-out section 12, takes in the banknotes in the receptacle 12A one note at a time through the take-in port 12C to be passed to the conveyance section 13, and conveys the banknotes to the temporary holding section 15 via the classification section 14. The banknote controller 11 then transitions to the next step SP9. At step SP9, similarly to at step SP3, the banknote controller 11 classifies each banknote being conveyed in sequence in the classification section 14, before transitioning to the next step SP10.

At step SP10, when the classification results from the classification section 14 have been obtained for all of the banknotes that have been taken in, the banknote controller 11 uses the classification information generation section 11C (FIG. 3) to count the number of banknotes of each denomination based on the classification results as post-dispensing classification information N2 such as that illustrated in FIG. 5B, and stores the post-dispensing classification information N2 in the storage section 11M. The banknote controller 11 then transitions to the next step SP11.

At step SP11, the banknote controller 11 compares the pre-dispensing classification information N1 and the post-dispensing classification information N2 stored in the storage section 11M against each other. The banknote controller 11 then transitions to the next step SP12. At step SP12, the banknote controller 11 determines whether or not the pre-dispensing classification information N1 and the post-dispensing classification information N2 match each other, namely whether or not the number of banknotes of each denomination is the same.

When a positive result is obtained, this means that the number of banknotes of each denomination matches between a point prior to dispensing at which the banknotes were housed in the receptacle 12A when the shutter 12B was initially opened, and a point after dispensing when the shutter 12B was closed and the banknotes were taken in from the receptacle 12A, and the likelihood of illicit activity or the like having taken place is low. When this occurs, the banknote controller 11 transitions to the next step SP13, and uses the conveyance section 13 to convey the banknotes stored in the temporary holding section 15 to the forgotten banknote storage box 19 in sequence. The banknote controller 11 then transitions to the next step SP15 and ends the pay-out processing routine RT1.

When a negative result is obtained at step SP12, this means that, as a minimum, the denominations and/or numbers do not match between prior to dispensing and after dispensing the banknotes, and there is a possibility of illicit activity such as swapping banknotes or pulling out some of the banknotes having taken place. The banknote controller 11 transitions to the next step SP14 when this occurs. At step SP14, the banknote controller 11 performs abnormality response processing, such as contacting a member of staff of the financial institution, before transitioning to the next step SP15 and ending the pay-out processing routine RT1.

Note that the storage section 11M continues to store both the pre-dispensing classification information N1 and the post-dispensing classification information N2 after the pay-out processing routine RT1 has ended. The banknote controller 11 is capable, for example, of displaying the contents of the pre-dispensing classification information N1 and the post-dispensing classification information N2 on the operation and display section 6 for confirmation, for example in response to a specific operation by a member of staff of the financial institution.

### 1-4. Operation and Advantageous Effects

In the above configuration, in the pay-out processing executed during a pay-out transaction with a user, the banknote pay-in/pay-out device 10 of the ATM 1 according to the first exemplary embodiment generates and stores the pre-dispensing classification information N1 expressing the number of banknotes of each denomination in the storage section 11M based on the classification information for the banknotes prior to pay-out. The banknote pay-in/pay-out device 10 then conveys the banknotes to the pay-in/pay-out section 12 and houses the banknotes in the receptacle 12A, opens the shutter 12B to dispense the banknotes, and prompts the user to take out the banknotes.

In cases in which the banknotes have been forgotten, the banknote pay-in/pay-out device 10 then generates the post-dispensing classification information N2 expressing the number of banknotes of each denomination based on the classification information for the banknotes after they have been taken in from the receptacle 12A of the pay-in/pay-out section 12, and stores the post-dispensing classification information N2 in the storage section 11M.

The banknote pay-in/pay-out device 10 then determines whether or not there is a difference between the pre-dispensing classification information N1 and the post-dispensing classification information N2. If there is no difference, the banknotes are conveyed to the forgotten banknote storage box 19, and if there is a difference, abnormality response processing is performed, for example to contact a member of staff of the financial institution.

Namely, the banknote pay-in/pay-out device 10 respectively generates and stores the pre-dispensing classification information N1 and the post-dispensing classification information N2 expressing the number of banknotes of each denomination, namely the number of each category when categorized by denomination, based on the classification results at respective points in time prior to dispensing the banknotes in the receptacle 12A, and when the banknotes have been forgotten after dispensing. Accordingly, by allowing a member of staff of the financial institution or the like to confirm the contents of the pre-dispensing classification information N1 and the post-dispensing classification information N2, the banknote pay-in/pay-out device 10 enables the change in the number of banknotes of each denomination between prior to dispensing and after dispensing to be easily identified, and employed as evidence to assist assessment as to whether or not illicit activity has taken place.

In the banknote pay-in/pay-out device 10, the pre-dispensing classification information N1 and the post-dispensing classification information N2 are compared by the banknote controller 11, and according to the results of the comparison, either the banknotes are conveyed to the forgotten banknote storage box 19, or the abnormality response processing is performed. This thereby enables a partial alleviation of the workload of the member of staff of the financial institution.

In either case, the banknote pay-in/pay-out device 10 counts the number of banknotes of each denomination as classification information. Accordingly, even if illicit activity has taken place that does not involve the use of counterfeit notes or changing the overall number of banknotes, for example replacing high value banknotes with genuine low value banknotes, this can be easily detected, or information leading to detection can be swiftly presented.

For example, in the pre-dispensing classification information N1 and the post-dispensing classification information N2 in FIG. 5A and FIG. 5B, the number of banknotes of each denomination changes for both 1000 yen banknotes and 10,000 yen banknotes. Based on this, determination that there is a high probability of illicit activity having taken place can be made easily.

Note that the classification section 14 includes a known function of detecting the denomination of each banknote and notifying the banknote controller 11 of the detection results. Accordingly, in the banknote pay-in/pay-out device 10, it is sufficient for the banknote controller 11 to additionally count the number of banknotes of each denomination based on the classification results obtained from the classification section 14, and store this in the storage section 11M as the pre-dispensing classification information N1 or the post-dispensing classification information N2, and there is no need to add additional sensors, modify the banknote conveyance paths, or the like.

According to the above configuration, the banknote pay-in/pay-out device 10 of the ATM 1 according to the first exemplary embodiment counts the number of banknotes of each denomination based on the classification information for the banknotes prior to dispensing and after dispensing in the receptacle 12A when forgotten banknotes arise in pay-out processing, thereby respectively generating the pre-dispensing classification information N1 and the post-dispensing classification information N2. The banknote pay-in/pay-out device 10 can thereby easily detect a change in the number of banknotes of each denomination between prior to dispensing and after dispensing by comparing the pre-dispensing classification information N1 against the post-dispensing classification information N2, and can facilitate the workload of a member of staff of the financial institution or the like when illicit activity has taken place.

### 2. Second Exemplary Embodiment

An ATM 101 (FIG. 1) according to a second exemplary embodiment differs from the ATM 1 according to the first exemplary embodiment in the point that a banknote pay-in/pay-out device 110 is provided in place of the banknote pay-in/pay-out device 10, and is configured similarly in other respects. The banknote pay-in/pay-out device 110 (FIG. 2 and FIG. 3) differs from the banknote pay-in/pay-out device 10 according to the first exemplary embodiment in the point that a banknote controller 111 is provided in place of the banknote controller 11, and is configured similarly in other respects.

Similarly to the banknote controller 11 according to the first exemplary embodiment, the banknote controller 111 is configured around a CPU, not illustrated in the drawings, and reads and executes specific programs from, for example, ROM or flash memory, not illustrated in the drawings, to perform various processing such as pay-in processing and pay-out processing.

The banknote controller 111 further includes a storage section 111M and a classification information generation section 111C in place of the storage section 11M and the classification information generation section 11C. Similarly to the storage section 11M, the storage section 111M is stored with various information such as the various programs, and classification information. The classification information generation section 111C generates classification information different from that of the first exemplary embodiment, based on classification information obtained from the classification section 14 (described in detail later). Note that the banknote controller 111 performs similar processing to the banknote controller 11 of the first exemplary embodiment during pay-in processing.

2-1. Pay-Out Processing

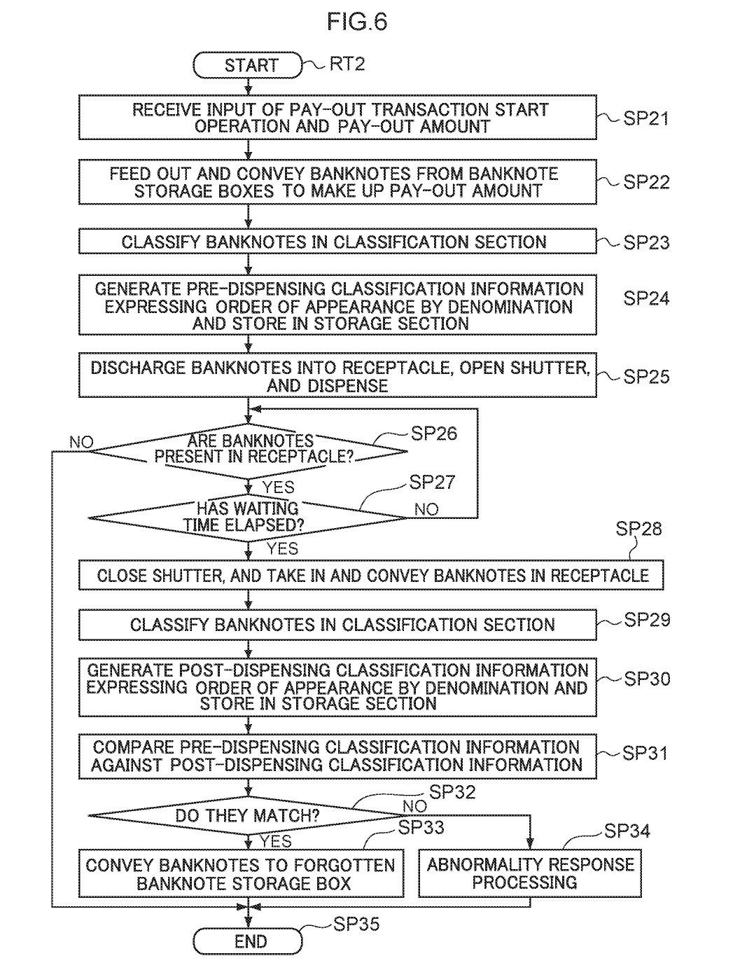

Next, explanation follows regarding banknote pay-out processing in the banknote pay-in/pay-out device 110. When a user performs a pay-out transaction with the ATM 101, the banknote controller 111 of the banknote pay-in/pay-out device 110 performs pay-out processing to pay out banknotes based on instructions from the user. Specifically, the banknote controller 111 reads and executes a pay-out program from the storage section 111M, starts the pay-out processing routine RT2 illustrated in FIG. 6 corresponding to FIG. 4, and transitions to step SP21.

At step SP21, step SP22, and step SP23, the banknote controller 111 performs processing similar to that of step SP1, step SP2, and step SP3 of the first exemplary embodiment. The banknote controller 111 then transitions to the next step SP24.

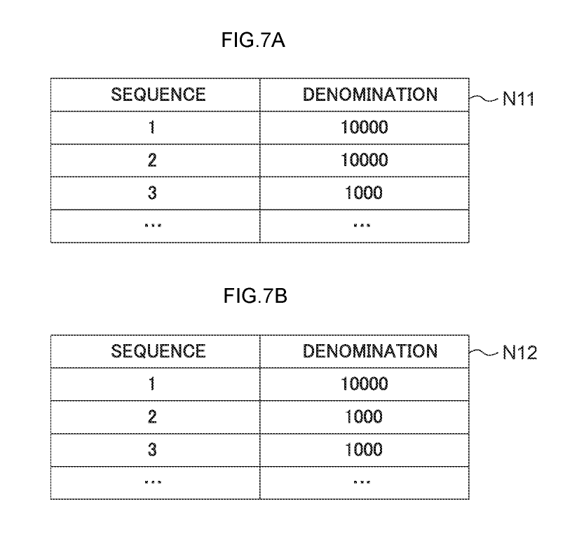

At step SP24, on obtaining classification results for all of the banknotes to be paid out from the classification section 14, based on the classification results, the banknote controller 111 uses the classification information generation section 111C (FIG. 3) to record banknote order of appearance by denomination as pre-dispensing classification information N11 such as that illustrated in FIG. 7A, and stores the pre-dispensing classification information N11 in the storage section 111M (FIG. 3). The banknote controller 111 then transitions to the next step SP25.

The “order of appearance by denomination” refers to associating and recording the sequence and denomination of each banknote that has passed the classification section 14. Due to the structure of the banknote pay-in/pay-out device 110, the banknotes conveyed in sequence by the conveyance section 13 arrive at the pay-in/pay-out section 12, and are discharged into the receptacle 12A from the discharge port 12D, in the sequence in which they pass the classification section 14. Accordingly, the order of appearance by denomination based on the classification results expresses the sequence in which each banknote appears when arranged in sequence from the front toward the rear when the banknotes are stacked in the receptacle 12A of the pay-in/pay-out section 12.

At step SP25, step SP26, step SP27, step SP28, and step SP29, the banknote controller 111 performs similar processing to at step SP5, step SP6, step SP7, step SP8, and step SP9 of the first exemplary embodiment. The banknote controller 111 then transitions to the next step SP30.

At step SP30, when the classification results from the classification section 14 have been obtained for all of the banknotes that have been taken in, the banknote controller 111 uses the classification information generation section 111C (FIG. 3) to record the banknote order of appearance by denomination based on the classification results as post-dispensing classification information N12 such as that illustrated in FIG. 7B, and stores the post-dispensing classification information N12 in the storage section 111M (FIG. 3). The banknote controller 111 then transitions to the next step SP31.

At step SP31, the banknote controller 111 compares the pre-dispensing classification information N11 and the post-dispensing classification information N12 stored in the storage section 111M against each other, and transitions to the next step SP32. At step SP32, the banknote controller 111 determines whether or not the pre-dispensing classification information N11 and the post-dispensing classification information N12 match each other, namely whether or not the banknote order of appearance by denomination is the same.

When a positive result is obtained, this means that the banknote order of appearance by denomination matches between a point prior to dispensing when the banknotes were housed in the receptacle 12A when the shutter 12B was initially opened, and a point after dispensing when the shutter 12B was closed and the banknotes were taken in from the receptacle 12A, and the likelihood of illicit activity or the like having taken place is low. When this occurs, the banknote controller 111 transitions to the next step SP33, and uses the conveyance section 13 to convey the banknotes stored in the temporary holding section 15 to the forgotten banknote storage box 19 in sequence. The banknote controller 111 then transitions to the next step SP35 and ends the pay-out processing routine RT2.

When a negative result is obtained at step SP32, this means that, as a minimum, the order of appearance by denomination does not match between prior to dispensing and after dispensing the banknotes, and there is a possibility of illicit activity such as swapping banknotes or pulling out some of the banknotes having taken place. The banknote controller 111 transitions to the next step SP34 when this occurs, and performs abnormality response processing, such as contacting a member of staff of the financial institution, before transitioning to the next step SP35 and ending the pay-out processing routine RT2.

Note that similarly to in the first exemplary embodiment, the storage section 111M continues to store both the pre-dispensing classification information N11 and the post-dispensing classification information N12 after the pay-out processing routine RT2 has ended. The banknote controller 111 is capable, for example, of displaying the contents of the pre-dispensing classification information N11 and the post-dispensing classification information N12 on the operation and display section 6 for confirmation, for example in response to a specific operation by a member of staff of the financial institution.

2-2. Operation and Advantageous Effects

In the above configuration, in the pay-out processing executed during a pay-out transaction with a user, the banknote pay-in/pay-out device 110 of the ATM 101 according to the second exemplary embodiment generates and stores the pre-dispensing classification information N11 expressing the order of appearance by denomination in the storage section 111M based on the classification information for the banknotes prior to pay-out. The banknote pay-in/pay-out device 110 then conveys the banknotes to the pay-in/pay-out section 12 and houses the banknotes in the receptacle 12A, opens the shutter 12B, and prompts the user to take out the banknotes.

In cases in which the banknotes have been forgotten, the banknote pay-in/pay-out device 110 then generates and stores in the storage section 111M the post-dispensing classification information N12 expressing the order of appearance by denomination based on the classification information for the banknotes after they have been taken in from the receptacle 12A of the pay-in/pay-out section 12. The banknote pay-in/pay-out device 110 then determines whether or not there is a difference between the pre-dispensing classification information N11 and the post-dispensing classification information N12. If there is no difference, the banknotes are conveyed to the forgotten banknote storage box 19, and if there is a difference, abnormality response processing is performed, for example to contact a member of staff of the financial institution.

Namely, the banknote pay-in/pay-out device 110 respectively generates and stores the pre-dispensing classification information N11 and the post-dispensing classification information N12 expressing the order of appearance by denomination, namely the order of appearance of each category when categorized by denomination, based on the classification results at respective points in time prior to dispensing the banknotes in the receptacle 12A, and when the banknotes have been forgotten after dispensing. Accordingly, by allowing a member of staff of the financial institution or the like to confirm the contents of the pre-dispensing classification information N11 and the post-dispensing classification information N12, the banknote pay-in/pay-out device 110 enables the change in the order of appearance by denomination between prior to dispensing and after dispensing to be easily identified, and employed as evidence to assist assessment as to whether or not illicit activity has taken place.

In the banknote pay-in/pay-out device 110, the pre-dispensing classification information N11 and the post-dispensing classification information N12 are compared by the banknote controller 111, and according to the results of the comparison, either the banknotes are conveyed to the forgotten banknote storage box 19, or the abnormality response processing is performed. This thereby enables a partial alleviation of the workload of the member of staff of the financial institution.

In either case, the banknote pay-in/pay-out device 110 records the banknote order of appearance by denomination as classification information. Accordingly, even if, for example, banknotes have been swapped, any change in the sequence of denominations can be easily detected, or information leading to detection can be presented.

For example, in the pre-dispensing classification information N11 and the post-dispensing classification information N12 in FIG. 7A and FIG. 7B, the denomination of the second banknote in sequence changes from 10,000 to 1000. Based on this, determination that there is a high probability of illicit activity having taken place can be made easily.

In other respects, the banknote pay-in/pay-out device 110 according to the second exemplary embodiment is capable of exhibiting similar operation and advantageous effects to the banknote pay-in/pay-out device 10 according to the first exemplary embodiment, with the exception of operation and advantageous effects relating to the contents of the classification information.

According to the above configuration, the banknote pay-in/pay-out device 110 of the ATM according to the second exemplary embodiment records the banknote order of appearance by denomination based on the classification information prior to dispensing and after dispensing the banknotes when forgotten banknotes arise in pay-out processing, thereby respectively generating the pre-dispensing classification information N11 and the post-dispensing classification information N12. The banknote pay-in/pay-out device 110 can thereby easily detect a change in the order of appearance by denomination in the banknotes prior to dispensing and after dispensing by comparing the pre-dispensing classification information N11 against the post-dispensing classification information N12, and can facilitate the workload of a member of staff of the financial institution or the like when illicit activity has taken place.

### 3. Third Exemplary Embodiment

An ATM 201 (FIG. 1) according to a third exemplary embodiment differs from the ATM 1 according to the first exemplary embodiment in the point that a banknote pay-in/pay-out device 210 is provided in place of the banknote pay-in/pay-out device 10, and is configured similarly in other respects. The banknote pay-in/pay-out device 210 (FIG. 2 and FIG. 3) differs from the banknote pay-in/pay-out device 10 according to the first exemplary embodiment in the point that a banknote controller 211 is provided in place of the banknote controller 11, and is configured similarly in other respects.

Similarly to the banknote controller 11 according to the first exemplary embodiment, the banknote controller 211 is configured around a CPU, not illustrated in the drawings, and reads and executes specific programs from, for example, ROM or flash memory, not illustrated in the drawings, to perform various processing such as pay-in processing and pay-out processing.

The banknote controller 211 further includes a storage section 211M and a classification information generation section 211C in place of the storage section 11M and the classification information generation section 11C. Similarly to the storage section 11M, the storage section 211M is stored with various information such as the various programs, and classification information. The classification information generation section 211C generates classification information different from that of the first and second exemplary embodiments, based on classification information obtained from the classification section 14 (described in detail later). Note that the banknote controller 211 performs similar processing to the banknote controller 11 of the first exemplary embodiment during pay-in processing.

3-1. Banknote Orientation and Classification Information

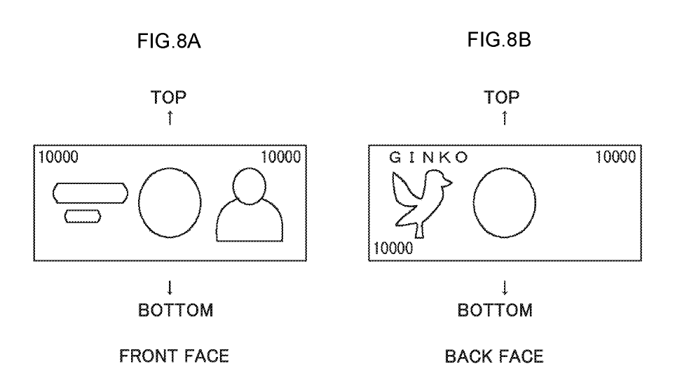

As illustrated in FIG. 8A and FIG. 8B, the banknotes handled by the ATM 201 are a rectangular, paper sheet shaped medium. Namely, the banknotes have a symmetrical shape in an up-down direction and a left-right direction as viewed toward the sheet face, and also have a shape with rotational symmetry when rotated about the left-right and up-down center.

The banknotes are printed with various text and images on their front faces and back faces respectively. The printed text and images, and printing specifications such as the layout, are asymmetrical in the up-down direction, and differ between the front face and the back face.

Note that when facing one face of a banknote with its long edges respectively at the top and bottom, this face is either the “front” or the “back” out of the front and back sheet faces of the banknote. The top and bottom of the banknote are either the “top” or the “bottom”. Note that the difference in the up-down orientation of the banknote may also be considered to be a difference of a rotation angle (0° or 180°) as rotated about the left-right and up-down center.

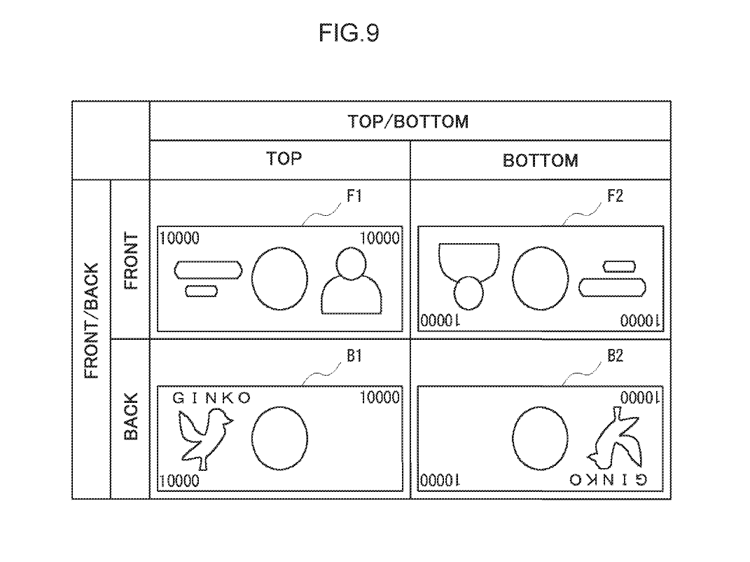

If banknotes are categorized by “orientations” that are combinations of the front or back and the top or bottom, each banknote may be considered to have four possible “orientations”, namely the states F1, F2, B1, and B2 illustrated in FIG. 9.

In the banknote pay-in/pay-out device 210 (FIG. 2), due to the placement and structure of the pay-in/pay-out section 12, the conveyance section 13, and the classification section 14, the face of a banknote that faces the side of the user in the receptacle 12A faces downward in the classification section 14, and the long edge that was at the top in the receptacle 12A is at the front in the classification section 14.

Accordingly, when a banknote is classified by the classification section 14 of the banknote pay-in/pay-out device 210, an “orientation”, namely “front or back” and “top or bottom” with reference to the front as viewed from a lower side of the banknote, is notified to the banknote controller 211 as classification information. Specifically, the classification section 14 classifies the orientation of each banknote based on an image obtained by an image sensor on the lower side of two image sensors (not illustrated in the drawings) that face each other across the banknote conveyance path from above and below.

3-2. Pay-Out Processing

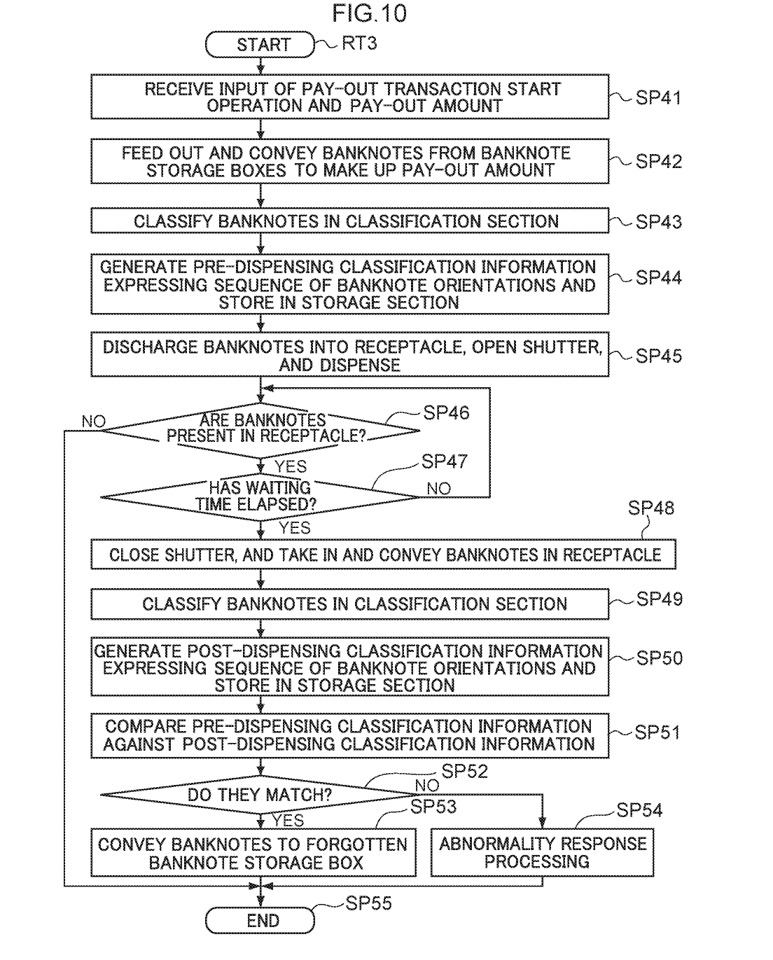

Next, explanation follows regarding banknote pay-out processing in the banknote pay-in/pay-out device 210. When a user performs a pay-out transaction with the ATM 201, the banknote controller 211 of the banknote pay-in/pay-out device 210 performs pay-out processing to pay out banknotes based on instructions from the user. Specifically, the banknote controller 211 reads and executes a pay-out program from the storage section 211M, starts the pay-out processing routine RT3 illustrated in FIG. 10 corresponding to FIG. 4, and transitions to step SP41.

At step SP41, step SP42, and step SP43, the banknote controller 211 performs processing similar to that of step SP1, step SP2, and step SP3 of the first exemplary embodiment. The banknote controller 211 then transitions to the next step SP44.

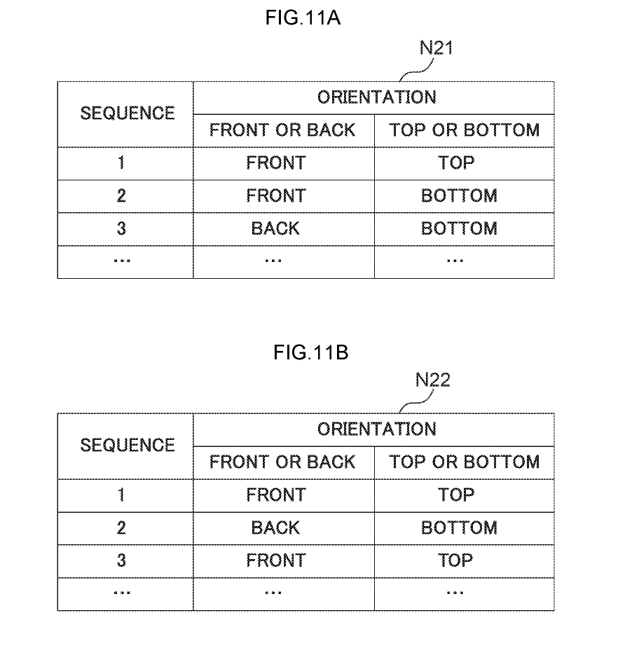

At step SP44, on obtaining classification results for all of the banknotes to be paid out from the classification section 14, based on the classification results, the banknote controller 211 uses the classification information generation section 211C (FIG. 3) to record a sequence of banknote orientations as pre-dispensing classification information N21 such as that illustrated in FIG. 11A, and stores the pre-dispensing classification information N21 in the storage section 211M (FIG. 3). The banknote controller 211 then transitions to the next step SP45. The banknote “orientations” are the four combinations of the front or back and the top or bottom of the banknote illustrated in FIG. 9.

At step SP45, step SP46, step SP47, step SP48, and step SP49, the banknote controller 211 performs similar processing to at step SP5, step SP6, step SP7, step SP8, and step SP9 of the first exemplary embodiment. The banknote controller 211 then transitions to the next step SP50.

At step SP50, when the classification results from the classification section 14 have been obtained for all of the banknotes that have been taken in, the banknote controller 211 uses the classification information generation section 211C (FIG. 3) to record the sequence of banknote orientations based on the classification results as post-dispensing classification information N22 such as that illustrated in FIG. 11B, and stores the post-dispensing classification information N22 in the storage section 211M (FIG. 3). The banknote controller 211 then transitions to the next step SP51.

At step SP51, the banknote controller 211 compares the pre-dispensing classification information N21 and the post-dispensing classification information N22 stored in the storage section 211M against each other, and transitions to the next step SP52. At step SP52, the banknote controller 211 determines whether or not the pre-dispensing classification information N21 and the post-dispensing classification information N22 match each other, namely whether or not the sequence of banknote orientations is the same.

When a positive result is obtained, this means that the sequence of banknote orientations matches between a point prior to dispensing when the banknotes were housed in the receptacle 12A when the shutter 12B was initially opened, and a point after dispensing when the shutter 12B was closed and the banknotes were taken in from the receptacle 12A, and the likelihood of illicit activity or the like having taken place is low. When this occurs, the banknote controller 211 transitions to the next step SP53, and uses the conveyance section 13 to convey the banknotes stored in the temporary holding section 15 to the forgotten banknote storage box 19 in sequence. The banknote controller 211 then transitions to the next step SP55 and ends the pay-out processing routine RT3.

When a negative result is obtained at step SP52, this means that, as a minimum, the sequence of banknote orientations does not match between prior to dispensing and after dispensing the banknotes, and there is a possibility of illicit activity such as swapping banknotes or pulling out some of the banknotes having taken place. The banknote controller 211 transitions to the next step SP54 when this occurs, and performs abnormality response processing, such as contacting a member of staff of the financial institution, before transitioning to the next step SP55 and ending the pay-out processing routine RT3.

Note that similarly to in the first exemplary embodiment, the storage section 211M continues to store both the pre-dispensing classification information N21 and the post-dispensing classification information N22 after the pay-out processing routine RT3 has ended. The banknote controller 211 is capable, for example, of displaying the contents of the pre-dispensing classification information N21 and the post-dispensing classification information N22 on the operation and display section 6 for confirmation, for example in response to a specific operation by a member of staff of the financial institution.

3-3. Operation and Advantageous Effects

In the above configuration, in the pay-out processing executed during a pay-out transaction with a user, the banknote pay-in/pay-out device 210 of the ATM 201 according to the third exemplary embodiment generates and stores the pre-dispensing classification information N21 expressing the sequence of banknote orientations in the storage section 211M based on the classification information for the banknotes prior to pay-out. The banknote pay-in/pay-out device 210 then conveys the banknotes to the pay-in/pay-out section 12 and houses the banknotes in the receptacle 12A, opens the shutter 12B, and prompts the user to take out the banknotes.

In cases in which the banknotes have been forgotten, the banknote pay-in/pay-out device 210 then generates and stores in the storage section 211M the post-dispensing classification information N22 expressing the sequence of banknote orientations based on the classification information for the banknotes after they have been taken in from the receptacle 12A of the pay-in/pay-out section 12. The banknote pay-in/pay-out device 210 then determines whether or not there is a difference between the pre-dispensing classification information N21 and the post-dispensing classification information N22. If there is no difference, the banknotes are conveyed to the forgotten banknote storage box 19, and if there is a difference, abnormality response processing is performed, for example to contact a member of staff of the financial institution.

Namely, the banknote pay-in/pay-out device 210 respectively generates and stores the pre-dispensing classification information N21 and the post-dispensing classification information N22 expressing the sequence of banknote orientations, namely the order of appearance by category when banknotes are categorized by orientation, based on the classification results at respective points in time prior to dispensing the banknotes in the receptacle 12A, and when the banknotes have been forgotten after dispensing. Accordingly, by allowing a member of staff of the financial institution or the like to confirm the contents of the pre-dispensing classification information N21 and the post-dispensing classification information N22, the banknote pay-in/pay-out device 210 enables the change in the sequence of banknote orientations between prior to dispensing and after dispensing to be easily identified, and employed as evidence to assist assessment as to whether or not illicit activity has taken place.

In the banknote pay-in/pay-out device 210, the pre-dispensing classification information N21 and the post-dispensing classification information N22 are compared by the banknote controller 211, and according to the results of the comparison, either the banknotes are conveyed to the forgotten banknote storage box 19, or the abnormality response processing is performed. This thereby enables a partial alleviation of the workload of the member of staff of the financial institution.

In either case, the banknote pay-in/pay-out device 210 records the sequence of banknote orientations as classification information. Accordingly, even if, for example, banknotes have been swapped, any change in the sequence of banknote orientations can be easily detected, or information leading to detection can be presented.

For example, in the pre-dispensing classification information N21 and the post-dispensing classification information N22 in FIG. 11A and FIG. 11B, the second banknote in sequence changes from front to back and from top to bottom. Based on this, determination that there is a high probability of illicit activity having taken place can be made easily.

In other respects, the banknote pay-in/pay-out device 210 according to the third exemplary embodiment is capable of exhibiting similar operation and advantageous effects to that of the banknote pay-in/pay-out device 10 according to the first exemplary embodiment, with the exception of operation and advantageous effects relating to the contents of the classification information.

According to the above configuration, the banknote pay-in/pay-out device 210 of the ATM according to the third exemplary embodiment records the sequence of banknote orientations based on the classification information prior to dispensing and after dispensing the banknotes when forgotten banknotes arise in pay-out processing, thereby respectively generating the pre-dispensing classification information N21 and the post-dispensing classification information N22. The banknote pay-in/pay-out device 210 can thereby easily detect a change in the sequence of banknote orientations prior to dispensing and after dispensing by comparing the pre-dispensing classification information N21 against the post-dispensing classification information N22, and can facilitate the workload of a member of staff of the financial institution or the like when illicit activity has taken place.

### 4. Fourth Exemplary Embodiment

An ATM 301 (FIG. 1) according to a fourth exemplary embodiment differs from the ATM 1 according to the first exemplary embodiment in the point that a banknote pay-in/pay-out device 310 is provided in place of the banknote pay-in/pay-out device 10, and is configured similarly in other respects. The banknote pay-in/pay-out device 310 (FIG. 2 and FIG. 3) differs from the banknote pay-in/pay-out device 10 according to the first exemplary embodiment in the point that a banknote controller 311 is provided in place of the banknote controller 11, and is configured similarly in other respects.

Similarly to the banknote controller 11 according to the first exemplary embodiment, the banknote controller 311 is configured around a CPU, not illustrated in the drawings, and reads and executes specific programs from, for example, ROM or flash memory, not illustrated in the drawings, to perform various processing such as pay-in processing and pay-out processing.

The banknote controller 311 further includes a storage section 311M and a classification information generation section 311C in place of the storage section 11M and the classification information generation section 11C. Similarly to the storage section 11M, the storage section 311M is stored with various information such as the various programs, and classification information. The classification information generation section 311C generates classification information different from that of the first to the third exemplary embodiments, based on classification information obtained from the classification section 14 (described in detail later). Note that the banknote controller 311 performs similar processing to the banknote controller 11 of the first exemplary embodiment during pay-in processing.

4-1. Pay-Out Processing

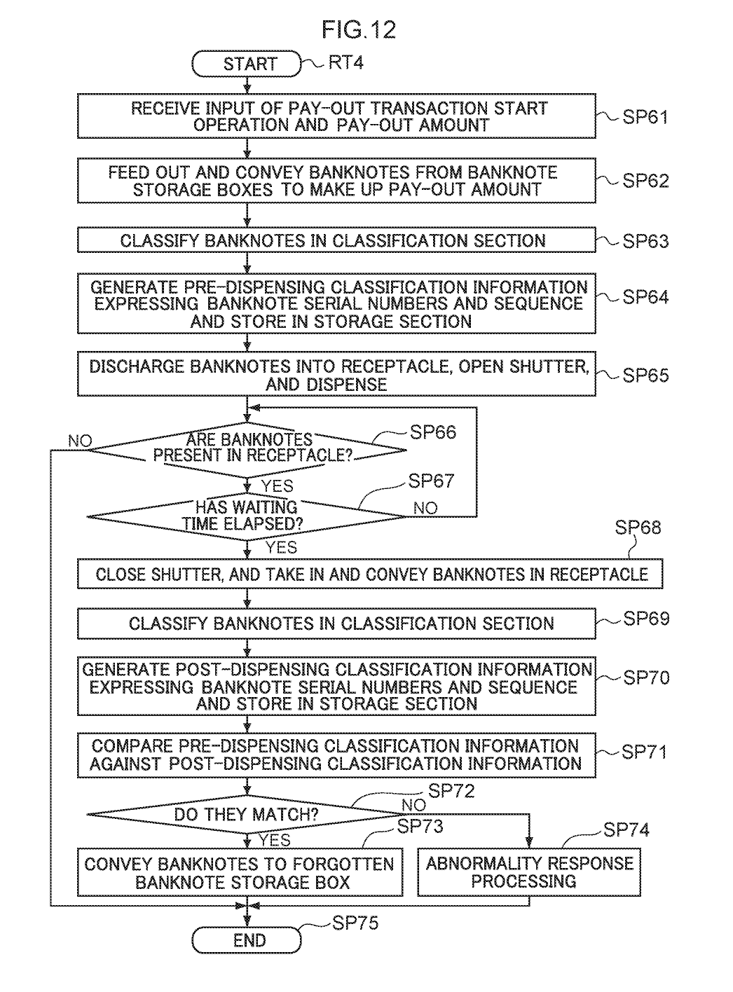

Next, explanation follows regarding banknote pay-out processing in the banknote pay-in/pay-out device 310. When a user performs a pay-out transaction with the ATM 301, the banknote controller 311 of the banknote pay-in/pay-out device 310 performs pay-out processing to pay out banknotes based on instructions from the user. Specifically, the banknote controller 311 reads and executes a pay-out program from the storage section 311M, starts the pay-out processing routine RT4 illustrated in FIG. 12 corresponding to FIG. 4, and transitions to step SP61.

At step SP61, step SP62, and step SP63, the banknote controller 311 performs processing similar to that of step SP1, step SP2, and step SP3 of the first exemplary embodiment. The banknote controller 311 then transitions to the next step SP64.

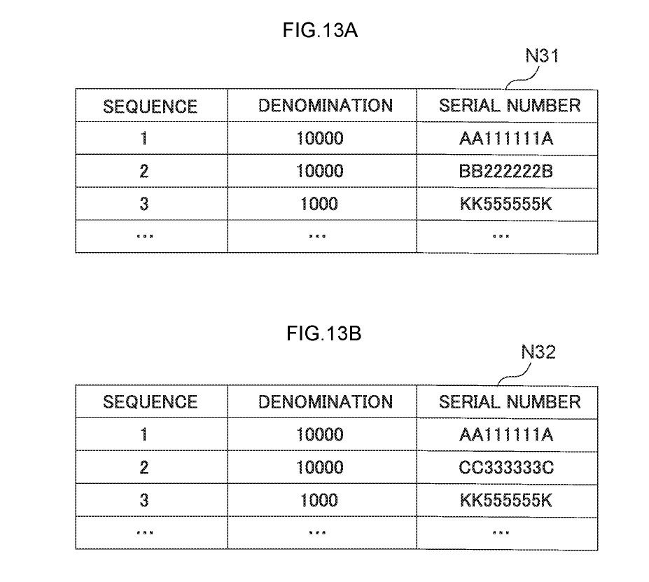

At step SP64, on obtaining classification results for all of the banknotes to be paid out from the classification section 14, based on the classification results, the banknote controller 311 uses the classification information generation section 311C (FIG. 3) to record the denominations, serial numbers, and sequence of the banknotes based on the classification results as pre-dispensing classification information N31 such as that illustrated in FIG. 13A, and stores the pre-dispensing classification information N31 in the storage section 311M (FIG. 3). The banknote controller 311 then transitions to the next step SP65.

At step SP65, step SP66, step SP67, step SP68, and step SP69, the banknote controller 311 performs similar processing to at step SP5, step SP6, step SP7, step SP8, and step SP9 of the first exemplary embodiment. The banknote controller 311 then transitions to the next step SP70.

At step SP70, when the classification results from the classification section 14 have been obtained for all of the banknotes that have been taken in, the banknote controller 311 uses the classification information generation section 311C (FIG. 3) to record the denominations, serial numbers, and sequence of the banknotes based on the classification results as post-dispensing classification information N32 such as that illustrated in FIG. 13B, and stores the post-dispensing classification information N32 in the storage section 311M (FIG. 3). The banknote controller 311 then transitions to the next step SP71.

At step SP71, the banknote controller 311 compares the pre-dispensing classification information N31 and the post-dispensing classification information N32 stored in the storage section 311M against each other, and transitions to the next step SP72. At step SP72, the banknote controller 311 determines whether or not the pre-dispensing classification information N31 and the post-dispensing classification information N32 match each other, namely whether or not the denominations, serial numbers, and sequence of the banknotes are the same.

When a positive result is obtained, this means that the denominations, serial numbers, and sequence of the banknotes match between a point prior to dispensing when the banknotes were housed in the receptacle 12A when the shutter 12B was initially opened, and a point after dispensing when the shutter 12B was closed and the banknotes were taken in from the receptacle 12A, and the likelihood of illicit activity or the like having taken place is low. When this occurs, the banknote controller 311 transitions to the next step SP73, and uses the conveyance section 13 to convey the banknotes stored in the temporary holding section 15 to the forgotten banknote storage box 19 in sequence. The banknote controller 311 then transitions to the next step SP75 and ends the pay-out processing routine RT4.

When a negative result is obtained at step SP72, this means that, as a minimum, the denomination, serial numbers, and sequence do not match between prior to dispensing and after dispensing the banknotes, and there is a possibility of illicit activity such as swapping banknotes or pulling out some of the banknotes having taken place. The banknote controller 311 transitions to the next step SP74 when this occurs, and performs abnormality response processing, such as contacting a member of staff of the financial institution, before transitioning to the next step SP75 and ending the pay-out processing routine RT4.

Note that similarly to in the first exemplary embodiment, the storage section 311M continues to store both the pre-dispensing classification information N31 and the post-dispensing classification information N32 after the pay-out processing routine RT4 has ended. The banknote controller 311 is capable, for example, of displaying the contents of the pre-dispensing classification information N31 and the post-dispensing classification information N32 on the operation and display section 6 for confirmation, for example in response to a specific operation by a member of staff of the financial institution.

4-2. Operation and Advantageous Effects

In the above configuration, in the pay-out processing executed during a pay-out transaction with a user, the banknote pay-in/pay-out device 310 of the ATM 301 according to the fourth exemplary embodiment generates and stores the pre-dispensing classification information N31 expressing the denominations, serial numbers, and sequence of the banknotes in the storage section 311M based on the classification information for the banknotes prior to pay-out. The banknote pay-in/pay-out device 310 then conveys the banknotes to the pay-in/pay-out section 12 and houses the banknotes in the receptacle 12A, opens the shutter 12B, and prompts the user to take out the banknotes.

In cases in which the banknotes have been forgotten, the banknote pay-in/pay-out device 310 then generates and stores in the storage section 311M the post-dispensing classification information N32 expressing the denominations, serial numbers, and sequence of the banknotes based on the classification information for the banknotes after they have been taken in from the receptacle 12A of the pay-in/pay-out section 12. The banknote pay-in/pay-out device 310 then determines whether or not there is a difference between the pre-dispensing classification information N31 and the post-dispensing classification information N32. If there is no difference, the banknotes are conveyed to the forgotten banknote storage box 19, and if there is a difference, abnormality response processing is performed, for example to contact a member of staff of the financial institution.

Namely, the banknote pay-in/pay-out device 310 respectively generates and stores the pre-dispensing classification information N31 and the post-dispensing classification information N32 expressing the denominations, serial numbers, and sequence of the banknotes based on the classification results at respective points in time prior to dispensing the banknotes in the receptacle 12A, and when the banknotes have been forgotten after dispensing. Accordingly, by allowing a member of staff of the financial institution or the like to confirm the contents of the pre-dispensing classification information N31 and the post-dispensing classification information N32, the banknote pay-in/pay-out device 310 enables the change in the denominations, serial numbers, and sequence of the banknotes between prior to dispensing and after dispensing to be easily identified, and employed as evidence to assist assessment as to whether or not illicit activity has taken place.

In the banknote pay-in/pay-out device 310, the pre-dispensing classification information N31 and the post-dispensing classification information N32 are compared by the banknote controller 311, and according to the results of the comparison, either the banknotes are conveyed to the forgotten banknote storage box 19, or the abnormality response processing is performed. This thereby enables a partial alleviation of the workload of the member of staff of the financial institution.

In either case, the banknote pay-in/pay-out device 310 records the denominations, serial numbers, and sequence of the banknotes as classification information. Accordingly, even if, for example, banknotes have been swapped, any change in the serial numbers themselves, or in the sequence thereof, can be easily detected, or information leading to detection can be presented.

For example, in the pre-dispensing classification information N31 and the post-dispensing classification information N32 in FIG. 13A and FIG. 13B, the serial number of the second banknote in the sequence has changed. Based on this, determination that there is a high probability of illicit activity having taken place can be made easily.

In other respects, the banknote pay-in/pay-out device 310 according to the fourth exemplary embodiment is capable of exhibiting similar operation and advantageous effects to the banknote pay-in/pay-out device 10 according to the first exemplary embodiment, with the exception of operation and advantageous effects relating to the contents of the classification information.

According to the above configuration, the banknote pay-in/pay-out device 310 of the ATM according to the fourth exemplary embodiment records the denominations, serial numbers, and sequence of the banknotes based on the classification information prior to dispensing and after dispensing the banknotes when forgotten banknotes arise in pay-out processing, thereby respectively generating the pre-dispensing classification information N31 and the post-dispensing classification information N32. The banknote pay-in/pay-out device 310 can thereby easily detect a change in the denominations, serial numbers, and sequence of the banknotes prior to dispensing and after dispensing by comparing the pre-dispensing classification information N31 against the post-dispensing classification information N32, and can facilitate the workload of a member of staff of the financial institution or the like when illicit activity has taken place.

### 5. Fifth Exemplary Embodiment

An ATM 401 (FIG. 1) according to a fifth exemplary embodiment differs from the ATM 1 according to the first exemplary embodiment in the point that a banknote pay-in/pay-out device 410 is provided in place of the banknote pay-in/pay-out device 10, and is configured similarly in other respects. The banknote pay-in/pay-out device 410 (FIG. 2 and FIG. 3) differs from the banknote pay-in/pay-out device 10 according to the first exemplary embodiment in the point that a banknote controller 411 and a pay-in/pay-out section 412 are provided in place of the banknote controller 11, and is configured similarly in other respects.

Similarly to the banknote controller 11 according to the first exemplary embodiment, the banknote controller 411 is configured around a CPU, not illustrated in the drawings, and reads and executes specific programs from, for example, ROM or flash memory, not illustrated in the drawings, to perform various processing such as pay-in processing and pay-out processing. Note that the banknote controller 411 performs similar processing to the banknote controller 11 of the first exemplary embodiment during pay-in processing.

5-1. Pay-in/Pay-Out Section Configuration

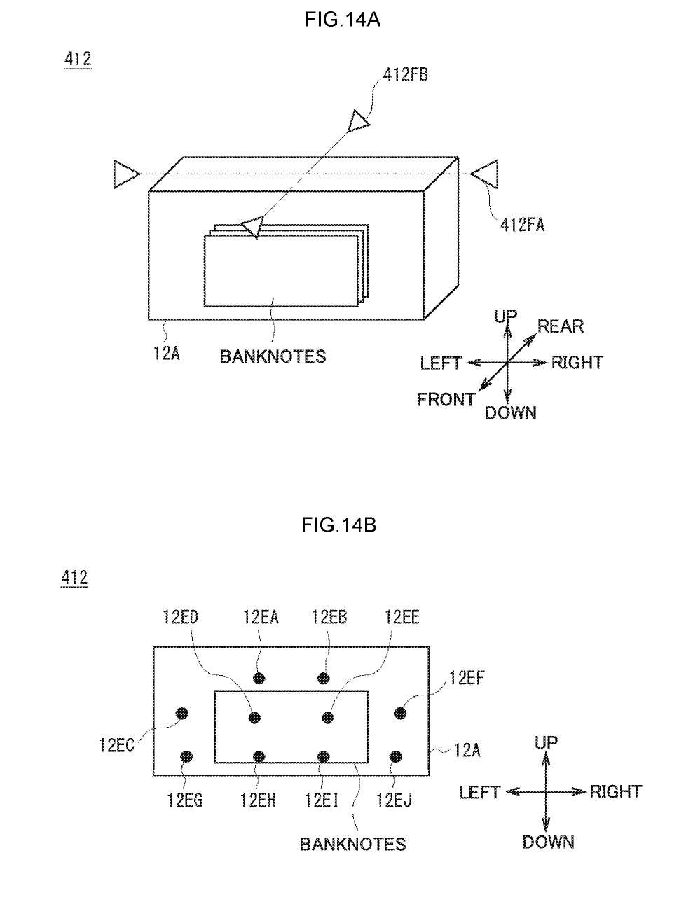

As illustrated in FIG. 14A, the pay-in/pay-out section 412 differs from the pay-in/pay-out section 12 according to the first exemplary embodiment in the point that hand detection sensors 412FA and 412FB are provided to detect the hand of the user. Other sections such as the receptacle 12A are configured similarly to in the pay-in/pay-out section 12.

The hand detection sensor 412FA is an optical sensor similar to the banknote detection sensor 12E (FIG. 2), and includes a light emitting element that emits a specific detection light and a light receiving element that receives the detection light, disposed at positions facing each other from the left and right across a space at the upper side of the receptacle 12A. The hand detection sensor 412FB likewise includes a light emitting element and a light receiving element disposed at positions facing each other from the front and rear across the space at the upper side of the receptacle 12A.

The hand detection sensors 412FA and 412FB do not detect whether or not banknotes are present inside the receptacle 12A, but detect whether or not the detection light has been blocked by the hand of the user approaching the receptacle 12A, or by banknotes held in the hand entering or leaving the receptacle 12A, and notify the banknote controller 411 of the detection results. In the following explanation, a space positioned above the receptacle 12A and through which the banknotes and hand of the user holding them pass when banknotes enter or leave the receptacle 12A is referred to as the transit space.

The banknote controller 411 identifies whether or not the light path of the detection light has been blocked, and on how many occasions, for example, by continuously monitoring the detection results of the hand detection sensors 412FA and 412FB of the pay-in/pay-out section 412. Based on the identification results, the banknote controller 411 can accordingly determine whether or not the hand of the user has approached the receptacle 12A, whether or not banknotes held by the hand of the user have passed through the transit space, the number of times the hand of the user has approached the receptacle 12A, the number of times that banknotes have passed through the transit space, or the like.

Note that as illustrated in FIG. 14B, the banknote detection sensor 12E is actually configured by 10 sets of banknote detection sensors 12EA, 12EB, 12EC, 12ED, 12EE, 12EF, 12EG, 12EH, 12EI, and 12EJ. These banknote detection sensors 12EA to 12EJ are disposed in a lattice shape as viewed from the front of the receptacle 12A, enabling the presence of various banknotes of different sizes to be detected with high precision.

The banknote controller 411 is capable of determining whether or not one or more banknotes are present inside the receptacle 12A based on the detection results of the banknote detection sensors 12EA to 12EJ. Moreover, the banknote controller 411 is capable of determining that a banknote has moved when a banknote in the receptacle 12A is moved and the detection results of the banknote detection sensors 12EA to 12EJ change.

5-2. Pay-Out Processing

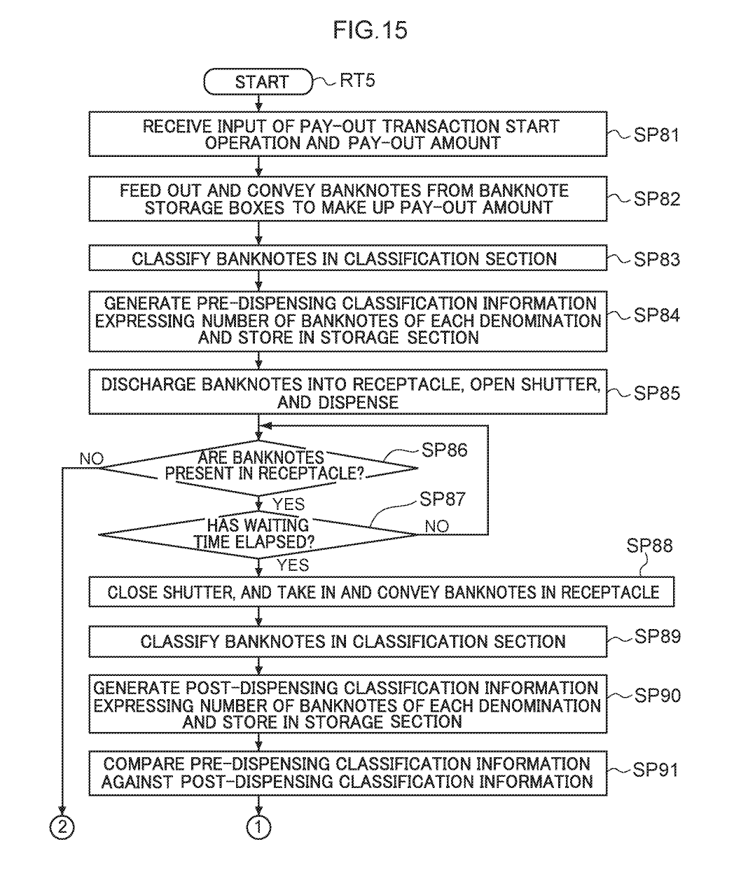

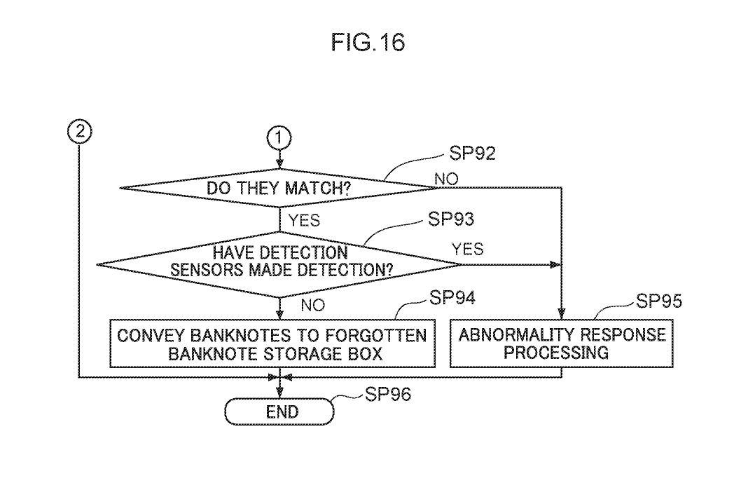

Next, explanation follows regarding banknote pay-out processing in the banknote pay-in/pay-out device 410. When a user performs a pay-out transaction with the ATM 401, the banknote controller 411 of the banknote pay-in/pay-out device 410 performs pay-out processing to pay out banknotes based on instructions from the user. Specifically, the banknote controller 411 reads and executes a pay-out program from the storage section 411M, starts the pay-out processing routine RT5 illustrated in FIG. 15 and FIG. 16 corresponding to FIG. 4, and transitions to step SP81.

At steps SP81 to SP92, the banknote controller 411 performs processing similar to that of steps SP1 to SP12 of the first exemplary embodiment. At the last of these steps, step SP92, the banknote controller 411 determines whether or not the pre-dispensing classification information N1 and the post-dispensing classification information N2 match each other, namely whether or not the number of banknotes of each denomination is the same.

When a positive result is obtained, this means that the number of banknotes of each denomination matches between a point prior to dispensing when the banknotes were housed in the receptacle 12A when the shutter 12B was initially opened, and a point after dispensing when the shutter 12B was closed and the banknotes were taken in from the receptacle 12A. When this occurs, processing transitions to the next step SP93.

At step SP93, the banknote controller 411 determines whether or not the detection light was blocked on one or more occasions while the shutter 12B was open based on the detection results obtained from the hand detection sensors 412FA and 412FB of the pay-in/pay-out section 412. Namely, the banknote controller 411 determines whether or not the hand of the user has accessed the receptacle 12A.

When a negative result is obtained, this means that the user has not inserted their hand into the pay-in/pay-out section 412 at all, and there is a high likelihood that they have simply forgotten to take the banknotes. When this occurs, the banknote controller 411 transitions to the next step SP94, and uses the conveyance section 13 to convey the banknotes stored in the temporary holding section 15 to the forgotten banknote storage box 19 in sequence. The banknote controller 411 then transitions to the next step SP96 and ends the pay-out processing routine RT5.

When a positive result is obtained at step SP93, this means that the detection light was blocked on one or more occasion by the hand of the user or a banknote while the shutter 12B was open, and that there is a possibility that illicit activity of some kind may have taken place, even if there is no change in the number of banknotes of each denomination between prior to dispensing and after dispensing. The banknote controller 411 transitions to the next step SP95 when this occurs. The banknote controller 411 also transitions to the next step SP95 when a negative result is obtained at step SP92, namely, when the number of banknotes of each denomination does not match between prior to dispensing and after dispensing.

At step SP95, similarly to at step SP14 (FIG. 4), the banknote controller 411 performs abnormality response processing, for example to contact a member of staff of the financial institution, before transitioning to the next step SP96 and ending the pay-out processing routine RT5.

5-3. Operation and Advantageous Effects

In the above configuration, the banknote pay-in/pay-out device 410 of the ATM 401 according to the fifth exemplary embodiment respectively generates and stores the pre-dispensing classification information N1 and the post-dispensing classification information N2 expressing the number of banknotes of each denomination based on the classification results at respective points in time prior to dispensing and after dispensing, similarly to in the first exemplary embodiment. When the pre-dispensing classification information N1 and the post-dispensing classification information N2 do not match, the banknote pay-in/pay-out device 410 performs abnormality response processing since there is a high likelihood of illicit activity having taken place.

Moreover, even if the pre-dispensing classification information N1 and the post-dispensing classification information N2 match each other, in cases in which blockage of the detection light was detected by the hand detection sensors 412FA and 412FB while the shutter 12B was open, the banknote pay-in/pay-out device 410 considers the hand of the user to have accessed the receptacle 12A and likewise performs abnormality response processing.

This thereby enables the banknote pay-in/pay-out device 410 to determine that there is a possibility of illicit activity having taken place, or to present evidence to assist assessment, based on the detection results of the hand detection sensors 412FA and 412FB even if sophisticated illicit activity that cannot be detected from the number of banknotes of each denomination has taken place, for example swapping paid out banknotes for counterfeit notes.

In other respects, the banknote pay-in/pay-out device 410 is capable of exhibiting similar operation and advantageous effects to the banknote pay-in/pay-out device 10 according to the first exemplary embodiment.

According to the above configuration, the banknote pay-in/pay-out device 410 of the ATM according to the fifth exemplary embodiment counts the number of banknotes of each denomination based on the classification information for the banknotes prior to dispensing and after dispensing when forgotten banknotes arise in pay-out processing, thereby respectively generating the pre-dispensing classification information N1 and the post-dispensing classification information N2. The banknote pay-in/pay-out device 410 can thereby easily detect a change in the number of banknotes of each denomination prior to dispensing and after dispensing by comparing the pre-dispensing classification information N1 against the post-dispensing classification information N2, and can determine whether or not the receptacle 12A has been accessed based on the detection results of the hand detection sensors 412FA and 412FB. This thereby enables the banknote pay-in/pay-out device 410 to facilitate the workload of a member of staff of the financial institution or the like when illicit activity has taken place.

### 6. Other Exemplary Embodiments

In the first exemplary embodiment described above, explanation has been given regarding a case in which the classification information is configured by the number of banknotes of each denomination at the respective points prior to dispensing and after dispensing. However, the present invention is not limited thereto, and, for example, the classification information may be configured by the number of banknotes of each of various categories when predetermined attributes of banknotes are categorized in various ways, for example by the number of banknotes of each orientation (either front and back or top and bottom, or combinations thereof) similarly to in the third exemplary embodiment, or by the year of issue in cases in which the year of issue is printed on the banknotes.

In the second exemplary embodiment described above, explanation has been given regarding a case in which the classification information is configured by the order of appearance by denomination of the banknotes at the respective points prior to dispensing and after dispensing. In the third exemplary embodiment, explanation has been given regarding a case in which the classification information is configured by the sequence of banknote orientations at the respective points prior to dispensing and after dispensing. However, the present invention is not limited thereto, and, for example, the classification information may be configured by the order of appearance of various categories when banknotes are categorized in various ways, for example by the level of damage of the banknotes.

In the third exemplary embodiment described above, explanation has been given regarding a case in which the classification information is configured by the four possible orientation combinations of the front or back and top or bottom of a banknote. However, the present invention is not limited thereto, and, for example, the classification information may be configured by the two possible orientations of the front or back of a banknote alone, or by the two possible orientations of the top or bottom of a banknote alone.

In the third exemplary embodiment described above, explanation has been given regarding a case in which the face orientations are categorized into the two possibilities of front or back, since paper sheet shaped banknotes are employed as the medium. However, the present invention is not limited thereto, and, for example, the classification information may be configured by categorizing respective media into the number of possible categories permitted by the shape of the medium, for example six possible categories of face orientation in cube or rectangular block shaped media.

In the third exemplary embodiment described above, since the banknotes serving as a medium are formed in rectangular shapes, explanation has been given regarding a case in which the rotation direction orientations are categorized into the two possibilities of 0° or 180°. However, the present invention is not limited thereto, and, for example, the classification information may be configured by categorizing rotation angles into four possibilities in cases in which there are four possible edges that could run in an upward direction in the pay-in/pay-out section 12 when the medium has a shape close to a square, namely in cases in which there are four possible rotation angles of a banknote with respect to a reference direction.

In the fourth exemplary embodiment described above, explanation has been given regarding a case in which the classification information is configured by the denominations, serial numbers, and sequence of the banknotes. However, the present invention is not limited thereto, and, for example, the classification information may be configured by the denomination and serial numbers alone, and not include the sequence.

In the fifth exemplary embodiment described above, explanation has been given regarding a case in which the detection results of the hand detection sensor 412FA and 412FB are employed when performing determination processing only in cases in which the pre-dispensing classification information N1 and the post-dispensing classification information N2 match each other. However, the present invention is not limited thereto, and, for example, in cases in which the pre-dispensing classification information N1 and the post-dispensing classification information N2 do not match, determination may be made that there is a low likelihood of illicit activity by the user if the detection light of the hand detection sensors 412FA and 412FB has not been blocked, and appropriate processing may be performed in response. Configuration may also be made such that determination processing employing the detection results of the hand detection sensors 412FA and 412FB is performed first, and comparison processing between the pre-dispensing classification information N1 and the post-dispensing classification information N2 is performed only in cases in which the detection light has been blocked.

In the present invention, various information expressing the medium collectively by category may be employed as the classification information in cases in which each banknote subject to classification is classified into two or more categories based on the classification results.

In the fifth exemplary embodiment described above, explanation has been given regarding a case in which the pre-dispensing classification information N1 and the post-dispensing classification information N2 that express the number of banknotes of each denomination are respectively generated and compared similarly to in the first exemplary embodiment, and the detection results of the hand detection sensors 412FA and 412FB are also employed. However, the present invention is not limited thereto, and the detection results of the hand detection sensors 412FA and 4121-B may also be employed in combination with various classification information that is generated and compared, for example in cases in which the pre-dispensing classification information N11 and the post-dispensing classification information N12 that express the order of appearance by denomination are respectively generated and compared, similarly to in the second exemplary embodiment.

In the fifth exemplary embodiment described above, explanation has been given regarding a case in which the pre-dispensing classification information N1 and the post-dispensing classification information N2 are referenced against each other when banknotes are left behind in the receptacle 12A after the banknotes have been paid out, namely when the banknotes have been forgotten. However, the present invention is not limited thereto, and, for example, configuration may be made in which the pre-dispensing classification information N1 and the post-dispensing classification information N2 are referenced against each other only in cases in which the banknotes have been forgotten and the detection results of other sensors such as the hand detection sensors 412FA and 412FB or the banknote detection sensor 12E have satisfied a specific referencing condition.

Specific examples of referencing conditions include detection by the hand detection sensors 412FA and 4121-B of banknotes or a hand passing through the transit space on a specific number of occasions or greater while the shutter 12B was open, or a change in the detection results of the banknote detection sensors 12EA to 12EJ between prior to dispensing and after dispensing, or a combination thereof.

In the first exemplary embodiment described above, explanation has been given regarding a case in which the pre-dispensing classification information N1 and the post-dispensing classification information N2 are compared against each other when banknotes are paid out to the user and the banknotes have been forgotten in a pay-out transaction. However, the present invention is not limited thereto, and, for example, the pre-dispensing classification information N1 and the post-dispensing classification information N2 may be compared against each other in a pay-in transaction, in cases in which a user gives an instruction to abandon the operation partway through, and then forgets the banknotes when the paid in banknotes are returned through the pay-in/pay-out section. Similar also applies to the second to the fifth exemplary embodiments.

In the first exemplary embodiment described above, explanation has been given regarding a case in which pay-out processing is executed by the banknote controller 11 of the banknote pay-in/pay-out device 10 according to the pay-out processing routine RT1 (FIG. 4). However, the present invention is not limited thereto, and, for example, pay-out processing may be independently performed by the main controller 9, or may be performed by the main controller 9 working together with the banknote controller 11. In such cases, there is no limitation to storing the classification information in the storage section 11M of the banknote controller 11, and the classification information may be stored in the storage section 9M of the main controller 9. Moreover, the classification information may be acquired externally using a communication means such as a network. Similar also applies to the second to the fifth exemplary embodiments.

In the first exemplary embodiment described above, explanation has been given regarding a case in which the pay-out program is stored in advance in the storage section 11M of the banknote controller 11. However, the present invention is not limited thereto, and, for example, the pay-out program may be stored in advance in the storage section 9M of the main controller 9, may be downloaded and acquired from an external server through a network, not illustrated in the drawings, or may be acquired from a removable storage means such as Universal Serial Bus (USB) memory through an interface, not illustrated in the drawings. Similar also applies to the second to the fifth exemplary embodiments.

In the first exemplary embodiment described above, explanation has been given regarding a case in which the present invention is applied to the banknote pay-in/pay-out device 10 of the ATM 1 that transacts banknotes, serving as a medium, with a user. However, the present invention is not limited thereto, and, for example, the present invention may be applied to various devices that exchange various media, such as cash vouchers or securities, with a user, and in particular, in cases in which a medium forgotten by the user is taken into the device. Similar also applies to the second to the fifth exemplary embodiments.

The present invention is not limited to the respective exemplary embodiments described above and the other exemplary embodiments described above. Namely, the present invention encompasses application to exemplary embodiments combining elements of some or all of the respective exemplary embodiments described above and the other exemplary embodiments described above, and exemplary embodiments deriving from elements thereof.

In the exemplary embodiments described above, explanation has been given regarding cases in which the banknote pay-in/pay-out device 10 serving as a medium processing device is configured by the classification section 14 serving as a classification section, the classification information generation section 11C serving as a classification information generation section, the pay-in/pay-out section 12 serving as an exchange section, the take-in port 12C serving as a take-in section, and the banknote controller 11 serving as a controller. However, the present invention is not limited thereto, and a medium processing device may be configured from classification sections, classification information generation sections, exchange sections, take-in sections, and controllers of various other configurations.

In the exemplary embodiment described above, explanation has been given regarding cases in which the ATM 1 serving as a medium transaction device is configured by the operation and display section 6 serving as an operation section, the classification section 14 serving as a classification section, the classification information generation section 11C serving as a classification information generation section, the pay-in/pay-out section 12 serving as an exchange section, the take-in port 12C serving as a take-in section, and the banknote controller 11 serving as a controller. However, the present invention is not limited thereto, and a medium transaction device may be configured from operation sections, classification sections, classification information generation sections, exchange sections, take-in sections, and controllers of various other configurations.

### INDUSTRIAL APPLICABILITY

The present invention may be employed in various devices that exchange a medium such as banknotes with a user.

The disclosure of Japanese Patent Application No. 2014-066787 is incorporated in its entirety by reference herein.

All cited documents, patent applications and technical standards mentioned in the present specification are incorporated by reference in the present specification to the same extent as if the individual cited document, patent application, or technical standard was specifically and individually indicated to be incorporated by reference.

1. A medium processing device comprising:
a classification section that classifies a medium;
a classification information generation section that, based on a classification result by the classification section, generates information relating to the medium subject to classification as classification information;
an exchange section that dispenses any of the medium to be exchanged with a user in a state in which the medium can be taken by the user;
a take-in section that takes in any of the medium left behind in the exchange section; and
a controller that causes the classification section to classify the medium to be exchanged with the user, that causes the classification information generation section to generate pre-dispensing classification information based on a classification result of the classification section for the medium prior to dispensing the medium into the exchange section, that causes the classification section to classify the medium taken in by the take-in section, that causes the classification information generation section to generate post-dispensing classification information based on a classification result of the classification section for the medium left behind in the exchange section after dispensing, and that determines any difference between the medium dispensed into the exchange section and the medium taken in by the take-in section based on the pre-dispensing classification information and the post-dispensing classification information.

2. The medium processing device of claim 1, wherein:
in cases in which the medium subject to classification is categorized into two or more categories based on the classification result of the classification section, the classification information generation section employs information expressing the medium collectively by category as the classification information; and
the controller determines any difference between the category of the medium that has been dispensed into the exchange section and the category of the medium that has been taken in by the take-in section based on the pre-dispensing classification information and the post-dispensing classification information.

3. The medium processing device of claim 2, wherein:
in cases in which the medium subject to classification is categorized into two or more categories based on the classification result of the classification section, the classification information generation section employs a quantity of the medium in each category as the classification information; and
the controller determines any difference between the quantity of the medium for each category of the medium dispensed into the exchange section and the quantity of the medium for each category of the medium taken in by the take-in section based on the pre-dispensing classification information and the post-dispensing classification information.

4. The medium processing device of claim 2, wherein:
the exchange section dispenses the medium to be exchanged with the user in a state in which the medium is arranged along a specific arrangement direction;
in cases in which the medium subject to classification is categorized into two or more categories based on the classification result of the classification section, the classification information generation section employs an order of appearance of each category in the arranged state as the classification information; and
the controller determines any difference between an order of appearance of each category in the medium dispensed into the exchange section and an order of appearance of each category of the medium taken in by the take-in section based on the pre-dispensing classification information and the post-dispensing classification information.

5. The medium processing device of claim 2, wherein the categories are based on a preset attribute of the medium.

6. The medium processing device of claim 2, wherein:
the exchange section is capable of dispensing the medium to the user in a plurality of possible orientations with reference to a specific reference direction; and
the categories are based on the orientation in which the medium is dispensed to the user in the exchange section.

7. The medium processing device of claim 6, wherein:
the medium includes a plurality of mutually different faces; and
the categories are based on which face of the medium faces in the specific reference direction in the exchange section.

8. The medium processing device of claim 7, wherein:
the medium is formed in a paper sheet shape and includes a first face and a second face; and
the categories are based on which out of the first face or the second face of the medium faces in the specific reference direction in the exchange section.

9. The medium processing device of claim 6, wherein:
the medium has a shape with rotational symmetry; and
the categories are based on a rotation angle of the medium with respect to the specific reference direction in the exchange section.

10. The medium processing device of claim 1, wherein:
each of the medium is allocated a unique identification number;
the classification section respectively classifies the identification number allocated to each of the medium;
based on the classification result of the classification section, the classification information generation section employs information relating to the identification number of the medium subject to classification as the classification information; and
the controller determines any difference between the identification number of the medium dispensed into the exchange section and the identification number of the medium taken in by the take-in section based on the pre-dispensing classification information and the post-dispensing classification information.

11. The medium processing device of claim 10, wherein:
based on the classification result of the classification section, the classification information generation section employs information relating to the identification number and the sequence of the medium subject to classification as the classification information; and
the controller determines any difference between the identification number and sequence of the medium dispensed into the exchange section and the identification number and sequence of the medium taken in by the take-in section based on the pre-dispensing classification information and the post-dispensing classification information.

12. The medium processing device of claim 1, further comprising
a hand detection sensor that detects that the medium or a hand of the user passes through a transit space through which the medium or a hand of the user passes when the medium enters or leaves the exchange section, wherein
the controller determines any difference between the medium dispensed into the exchange section and the medium taken in by the take-in section based on the pre-dispensing classification information and the post-dispensing classification information only in cases in which the medium or the hand of the user has been detected by the hand detection sensor as having passed through the transit space on a specific number of occasions or greater.

13. The medium processing device of claim 1, wherein:
the exchange section further includes two or more medium sensors that detect the presence or absence of the medium; and
the controller determines any difference between the medium dispensed into the exchange section and the medium taken in by the take-in section based on the pre-dispensing classification information and the post-dispensing classification information only in cases in which a detection result of the medium by the medium sensors has changed between before and after the medium was dispensed into the exchange section.

14. A medium transaction device comprising:
an operation section that receives an operation instruction to perform a transaction involving an exchange of a medium with a user;
a classification section that classifies the medium;
a classification information generation section that, based on a classification result by the classification section, generates information relating to the medium subject to exchange as classification information;
an exchange section that dispenses any of the medium subject to exchange in a state in which the medium can be taken by the user;
a take-in section that takes in any of the medium left behind in the exchange section; and
a controller that causes the classification section to classify the medium subject to exchange, that causes the classification information generation section to generate pre-dispensing classification information based on a classification result of the classification section for the medium prior to dispensing the medium into the exchange section, that causes the classification section to classify the medium taken in by the take-in section, that causes the classification information generation section to generate post-dispensing classification information based on a classification result of the classification section for the medium left behind in the exchange section after dispensing, and that determines any difference between the medium dispensed into the exchange section and the medium taken in by the take-in section based on the pre-dispensing classification information and the post-dispensing classification information.

15. The medium transaction device of claim 14, wherein:
the transaction is a withdrawal transaction in which the user withdraws the medium from the medium transaction device; and
the exchange section employs the medium withdrawn in the withdrawal transaction as a subject of the exchange.

16. The medium transaction device of claim 14, wherein:
the transaction is a deposit transaction in which the user deposits the medium in the medium transaction device; and
the exchange section employs the medium to be returned to the user as a subject of the exchange in cases in which the deposit transaction is abandoned after the medium has been received from the user.
